(19) United States
(12) Patent Application Publication
(10) Pub. No.: US 2003/0019753 A1
(43) Pub. Date: Jan. 30, 2003

(54) Multi-port separation apparatus and method

(76) Inventors: David Ogle, Cowan (AU); Gyula Vigh, Magnolia, TX (US); Dennis Brian Rylatt, Ryde (AU)

Correspondence Address: BAKER & MCKENZIE, 805 THIRD AVENUE, NEW YORK, NY, 10022, US

(21) Appl. No.: 09/972,436

(22) Filed: Oct. 5, 2001

(30) Foreign Application Priority Data
Oct. 5, 2000 (AU) PR0592
Dec. 5, 2000 (AU) PR1895

(51) Int. Cl. G01N 27/26; G01N 27/447

(52) U.S. Cl. 204/548; 204/518; 204/627; 204/644

(57) ABSTRACT

A multi-port electrophoresis system comprising: first and second electrode chambers containing a cathode and an anode respectively, wherein the electrode chambers are disposed relative to one another so that the electrodes are adapted to generate an electric field upon application of a selected electric potential therebetween; at least three adjacently disposed separation chambers disposed between the electrode chambers and separated from adjacent separation chambers and the electrode chambers by ion-permeable barriers adapted to impede convective mixing of the contents of adjacent chambers; a first electrolyte reservoir in fluid communication with at least one of the electrode chambers; at least one sample reservoir in fluid communication with at least one of the separation chambers; means adapted for communicating fluids to the first and second electrode chambers and to the at least three separation chambers; means adapted for communicating an electrolyte between the electrolyte reservoir and at least one of the first and second electrode chambers; and means adapted for communicating at least one fluid between at least one separation chamber and the at least one sample reservoir; wherein application of the selected electric potential causes migration of at least one component through at least one of the ion-permeable barriers.

### BACKGROUND OF THE INVENTION

This invention relates to an apparatus for separation of compounds in solution by electrophoresis, a separation unit and cartridge suitable for the apparatus, and methods of use of the apparatus.

Preparative scale electrophoretic separations are becoming important for the processing of both simple and complex samples. A key element determining the success of such separation is the extent to which convective re-mixing of the separated components can be prevented. Multicompartnent electrolyzers are considered attractive for preparative-scale electrophoretic separations because separated components of a sample can be readily isolated in space and/or time. Many of the multicompartment electrolyzers suffer from the improper integration of the electrophoretic and hydraulic transport trajectories. Recently, the Gradiflow™ technology (owned by Gradipore Limited) was introduced to favorably implement the integration of the electrophoretic and hydraulic processes involved in the preparative-scale electrophoretic separation of components. Despite its favorable characteristics, the Gradiflow™ technology was limited in the sense that it implemented two separation chambers isolated from each other and the electrode chambers by electrophoresis separation membranes that essentially prevented convective mixing of the contents of adjacent chambers. This design limited the Gradiflow™ technology to binary separations, albeit by sequential binary separations, individual components could also be separated from complex mixtures.

It is desirable to have a multichamber electrolyzer which extends the application field of separation technology from binary separations to the simultaneous separation of multiple components from complex mixtures.

### SUMMARY OF THE INVENTION

In accordance with the present invention, there is provided a multichamber electrolyzer which extends the application field of separation technology from binary separations to the simultaneous separation of multiple components from complex mixtures.

Further, in accordance with the present invention, there is provided an apparatus and method that can effectively and efficiently process and separate charged molecules and other components in samples.

Still further, in accordance with the present invention, there is provided a multi-port electrophoresis system comprising:

a first electrode chamber containing a cathode;

a second electrode chamber containing an anode, wherein the second electrode chamber is disposed relative to the first electrode chamber so that the cathode and anode are adapted to generate an electric field in an electric field area upon application of a selected electric potential therebetween;

at least three adjacently disposed separation chambers disposed between the cathode and anode chambers so as to be at least partially disposed in the electric field area, wherein each separation chamber is separated from an adjacent separation chamber by a common ion-permeable barrier, wherein separation chambers proximate to each electrode chamber are separated from the respective electrode chamber by at least one ion-permeable barrier, and wherein the ion-permeable barriers are adapted to impede convective mixing of the contents of adjacent chambers;

a first electrolyte reservoir in fluid communication with at least one of the electrode chambers;

at least one sample reservoir, wherein each of the at least one sample reservoirs is in fluid communication with at least one of the separation chambers;

means adapted for communicating fluids to the first and second electrode chambers;

means adapted for communicating an electrolyte between the electrolyte reservoir and at least one of the first and second electrode chambers;

means adapted for communicating fluids to the three separation chambers wherein at least one of the fluids contains a sample; and

means adapted for communicating at least one fluid between at least one separation chamber and the at least one sample reservoir;

wherein application of the selected electric potential causes migration of at least one component through at least one of the ion-permeable barriers.

Preferably, the apparatus comprises two electrolyte reservoirs, a catholyte reservoir in fluid communication with the cathode chamber and an anolyte reservoir in fluid communication with the anode chamber.

Preferably, the apparatus comprises between four and twelve separation chambers having between four and twelve corresponding sample reservoirs in fluid communication with a respective separation chamber. The apparatus suitably has any number of separation chambers, preferably three, four, five, six, seven, eight, nine, ten, eleven, twelve or more. The apparatus suitably has any number of separation reservoirs, preferably three, four, five, six, seven, eight, nine, ten, eleven, twelve or more. In one embodiment, there is one sample reservoir for each separation chamber or alternatively, any sample reservoir can be in fluid communication with more than one separation chamber.

Preferably, at least one of the barriers restricts convective mixing of contents in adjacent chambers and prevents substantial movement of components in the absence of an electric field.

In one preferred form, the barriers are membranes having characteristic average pore sizes and pore size distributions. In another preferred form, at least one of the barriers is an isoelectric membrane having a characteristic pI value.

In another preferred form, least one of the barriers is an ion-exchange membrane capable of allowing or impeding selective migration of ions.

It will be appreciated that the apparatus suitably has the same type of ion-permeable barriers or a combination of two or more types, depending on the desired separation or treatment of a given sample.

In a preferred embodiment, at least two of the separation chambers are in serial fluid communication such that fluids first flow through a selected one of the separation chambers and upon exiting the selected one of the separation chambers, the fluids enter the other chamber and flow through the other chamber.

In one preferred embodiment, each separation chamber contains inlet and outlet means that are in fluid communication with that chamber.

In another preferred embodiment, at least two separation chambers are in fluid communication via the same inlet and outlet means. In another preferred embodiment, at least one separation chamber is in fluid communication with at least one other chamber via an external fluid communication means.

In another preferred embodiment, at least two of the separation chambers are in parallel fluid communication such that the same fluids flow through the at least two separation chambers. In another preferred embodiment, the direction of flow in the at least two separation chambers is the same. In another preferred embodiment, the direction of flow in at least one of the at least two separation chambers in parallel fluid communications is anti-parallel.

Still further, in accordance with the present invention, there is provided an electrophoresis separation unit comprising:

a first electrode chamber containing a cathode;

a second electrode chamber containing an anode, wherein the second electrode chamber is disposed relative to the first electrode chamber so that the cathode and anode are adapted to generate an electric field in an electric field area upon application of a selected electric potential therebetween;

at least three adjacently disposed separation chambers disposed between the cathode and anode chambers so as to be at least partially disposed in the electric field area, wherein each separation chamber is separated from an adjacent separation chamber by a common ion-permeable barrier, wherein separation chambers proximate to each electrode chamber are separated from the respective electrode chamber by at least one ion-permeable barrier, and wherein the ion-permeable barriers are adapted to impede convective mixing of the contents of adjacent chambers;

means adapted for communicating fluids to the first and second electrode chambers; and

means adapted for communicating fluids to the at least three separation chambers wherein at least one of the fluids contains a sample;

wherein application of the selected electric potential causes migration of at least one component through at least one of the ion-permeable barriers.

Preferably, the unit comprises between three and twelve separation chambers. The unit can have any number of separation chambers, preferably three, four, five, six, seven, eight, nine, ten, eleven, twelve or more.

Preferably, at least one of the barriers restricts convective mixing of contents in adjacent chambers and prevents substantial movement of components in the absence of an electric field.

Preferably, the barriers are membranes having characteristic average pore sizes and pore size distributions. In one preferred form, at least one of the barriers is an isoelectric membrane having a characteristic pI value.

In another preferred form, at least one of the barriers is an ion-exchange membrane capable of allowing or impeding selective migration of ions.

It will be appreciated that the unit suitably has the same type of ion-permeable barriers or a combination of two or more types, depending on the desired separation or treatment of a given sample.

In one preferred embodiment, each separation chamber contains inlet and outlet means that are in fluid communication with that chamber.

In another preferred embodiment, at least two separation chambers are in fluid communication via the same inlet and outlet means. In another preferred embodiment, at least one separation chamber is in fluid communication with at least one other chamber via an external fluid communication means.

In a preferred embodiment, at least two of the separation chambers are in serial fluid communication such that fluids first flow through a selected one of the separation chambers and upon exiting the selected one of the separation chambers, the fluids enter the other chamber and flow through the other chamber.

In another preferred embodiment, at least two of the separation chambers are in parallel fluid communication such that the same fluids flow through the at least two separation chambers. In another preferred embodiment, the direction of flow in the at least two separation chambers is the same. In another preferred embodiment, the direction of flow in at least one of the at least two separation chambers in parallel fluid communications is anti-parallel.

In a preferred form, the separation chambers are formed or housed in a cartridge which is adapted to be removable from the unit.

Still further, in accordance with the present invention, there is provided a cartridge for use in an electrophoresis unit comprising:

a housing including a base section and a plurality of sidewalls sealingly connected thereto so as to define an interior portion;

a first outer ion-permeable barrier disposed within the interior of the housing;

a second outer ion-permeable barrier disposed within the interior of the housing and relative to the first outer ion-permeable barrier so as to define a volume therebetween;

at least two inner ion-permeable barriers disposed between the outer ion-permeable barriers so as to define three adjacently disposed separation chambers, wherein each separation chamber is separated from an adjacent separation chamber by a common ion-permeable barrier, wherein the ion-permeable barriers are adapted to impede convective mixing of the contents of adjacent chambers; and

means adapted for communicating fluids to at least one of the separation chambers.

In one preferred form, the cartridge comprises two to eleven barriers defining three to twelve separation chambers.

Preferably, at least one of the barriers restricts convective mixing of contents in adjacent chambers and prevents substantial movement of components in the absence of an electric field.

The barriers are preferably membranes having characteristic average pore sizes and pore size distributions. At least one of the barriers may be an isoelectric membrane having a characteristic pI value.

At least one of the barriers may be an ion-exchange membrane capable of allowing or impeding selective migration of ions.

It will be appreciated that the cartridge can have the same type of ion-permeable barriers or a combination of two or more types, depending on the desired separation or treatment of a given sample.

In one preferred embodiment, each separation chamber contains inlet and outlet means that are in fluid communication with that chamber.

In another preferred embodiment, at least two separation chambers are in fluid communication via the same inlet and outlet means. In another preferred embodiment, at least one separation chamber is in fluid communication with at least one other chamber via an external fluid communication means.

Still further, in accordance with the present invention, there is provided a method for altering the composition of a sample by electrophoresis comprising:

communicating a first electrolyte to a first electrode chamber containing a cathode;

communicating a second electrolyte to a second electrode chamber containing an anode, wherein the second electrode chamber is disposed relative to the first electrode chamber so that the cathode and anode are adapted to generate an electric field in an electric field area upon application of a selected electric potential therebetween, wherein at least one of the electrode chambers is in fluid communication with an electrolyte reservoir, wherein the second electrolyte is selected from the group consisting of the first electrolyte and an electrolyte different from the first electrolyte;

communicating fluids to at least three adjacently disposed separation chambers disposed between the cathode and anode chambers so as to be at least partially disposed in the electric field area, wherein each separation chamber is separated from an adjacent separation chamber by a common ion-permeable barrier, wherein separation chambers proximate to each electrode chamber are separated from the respective electrode chamber by at least one ion-permeable barrier, and wherein the ion-permeable barriers are adapted to impede convective mixing of the contents of adjacent chambers, wherein at least one of the separation chambers is in fluid communication with at least one sample reservoir, wherein at least one of the fluids contains a sample;

applying of the selected electric potential causes migration of at least one component through at least one of the ion-permeable barriers into at least one the adjacent chambers.

Preferably, substantially all trans-barrier movement of components is initiated by the application of the electric potential.

Preferably, at least one of the barriers restricts convective mixing of contents in adjacent chambers and prevents substantial movement of components in the absence of an electric field.

Preferably, the barriers are membranes having characteristic average pore sizes and pore size distributions. At least one of the barriers may be an isoelectric membrane having a characteristic pI value. At least one of the barriers may be an ion-exchange membrane capable of mediating selective movement of ions.

It will be appreciated that the same type of ion-permeable barriers or a combination of two or more types, depending on the desired separation or treatment of a given sample can be used.

Gradiflow™ is a trade mark of Gradipore Limited, Australia.

An advantage of the present invention is that the apparatus and method can effectively and efficiently process and separate charged molecules and other components in samples.

Another advantage of the present invention is that the apparatus and method have scale-up capabilities, increased separation speed, lower cost of operation, lower power requirements, and greater ease of use.

Yet another advantage of the present invention is that the apparatus and method have improved yields of the separated component and improved purity of the separated component.

Yet another advantage of the present invention is that the apparatus and method allows the treatment or processing of multiple samples simultaneously.

These and other advantages will be apparent to one skilled in the art upon reading and understanding the specification.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any description of prior art documents herein is not an admission that the documents form part of the common general knowledge of the relevant art in Australia.

In order that the present invention may be more clearly understood, preferred forms will be described with reference to the following examples and drawings.

### BRIEF DESCRIPTION OF DRAWINGS

FIG. 1 is a schematic diagram of an electrophoresis separation unit having four separation chambers for use in the electrophoresis apparatus of the present invention.

FIG. 2 is a schematic diagram of an electrophoresis separation unit having six separation chambers for use in the electrophoresis apparatus of the present invention.

FIG. 3 is a schematic diagram of alternative embodiment of an electrophoresis separation unit having six separation chambers for use in the electrophoresis apparatus of the present invention.

FIG. 4 is a schematic diagram of an electrophoresis separation unit having twelve separation chambers for use in the electrophoresis apparatus of the present invention.

FIG. 5A is an exploded view of an electrophoresis separation unit capable of having twelve separation chambers for use in the electrophoresis apparatus of the present invention.

FIG. 5B is a view of an electrophoresis separation unit according to FIG. 5A partially assembled in a suitable housing.

FIG. 5C is a view of an electrophoresis separation unit according to FIG. 5A fully assembled in a suitable housing.

FIG. 6A is a plan view of a first grid element which can be incorporated as a component of an electrophoresis separation unit or cartridge of the present invention.

FIG. 6B is a plan view of a second grid element which can be incorporated as a component of an electrophoresis separation unit or cartridge of the present invention.

FIG. 6C is a plan view of a third grid element which can be incorporated as a component of an electrophoresis separation unit or cartridge of the present invention.

FIG. 7 is an exploded view of the inner components of an electrophoresis separation unit or cartridge having three separation chambers.

FIG. 8 is an exploded view of the inner components of an electrophoresis separation unit or cartridge having four separation chambers.

FIG. 9 is an exploded view of the inner components of an electrophoresis separation unit or cartridge having six separation chambers.

FIG. 10 is an exploded view of the inner components of an electrophoresis separation unit or cartridge having twelve separation chambers.

FIG. 11 is a schematic representation of an electrophoresis apparatus utilizing a separation unit of FIG. 1.

FIG. 12 is a line diagram of an electrophoresis apparatus utilizing a separation unit having twelve separation chambers.

FIG. 13 shows analytical SDS-PAGE results for the sample harvested after 60, 120, and 180 minutes of electrophoresis during the separation of IgG from human plasma in Example 1. Lane 1: feed sample; Lanes 2, 3, 4: analytical results after 60 min of electrophoresis; Lanes 5, 6, 7: analytical results after 120 min of electrophoresis; and Lanes 8, 9, 10: analytical results after 180 min of electrophoresis. Transfer of IgG from the sample stream to the product stream was evident at the first analysis point at 60 mins.

FIG. 14 shows analytical SDS-PAGE results for the samples harvested after 4 hours of electrophoresis of a human plasma sample in Example 2. Lanes 1 and 2: separation chambers 12 and 11. Lanes 3 to 10: separation chambers 10 to 3.

FIG. 15 shows the image of an SDS-PAGE separation of the contents of the separation chambers after 4 hours of electrophoresis in a Example 3. Lysozyme from egg white (molecular mass 14 kDa, isoelectric point of 10) moved into separation chambers 11 and 12 (between the 3 kDa-15 kDa and 15 kDa-1000 kDa membranes), because this protein is positively charged at pH 8.5 (Lanes 1 and 2). Negatively charged proteins moved toward the anode (Lanes 3-10): the smaller the size of the protein, the farther away it moved from chamber 10 which was the feed point for the sample.

FIG. 16 shows the image of an SDS-PAGE separation of the contents of the separation chambers after 4 hours of electrolysis in Example 4. Lanes 1, 3, 5, 7 and 9: analytical results for the product streams after 60 min of electrophoresis; Lanes 2, 4, 6, 8 and 10: analytical results for the lower pi components left over after 60 min of electrophoresis.

FIG. 17 shows the image of a Western blot of the same separation as FIG. 16, with an antibody against AAT.

### DETAILED DESCRIPTION OF THE INVENTION

Before describing the preferred embodiments in detail, the principal of operation of the apparatus will first be described. An electric field or potential applied to ions in solution will cause the ions to move toward one of the electrodes. If the ion has a positive charge, it will move toward the negative electrode (cathode). Conversely, a negatively-charged ion will move toward the positive electrode (anode).

In the apparatus of the present invention, ion-permeable barriers that substantially prevent convective mixing between the adjacent chambers of the apparatus or unit are placed in an electric field and components of the sample are selectively transported through the barriers. The particular ion-permeable barriers used will vary for different applications and generally have characteristic average pore sizes and pore size distributions, isoelectric points or other physical characteristics allowing or substantially preventing passage of different components.

Having outlined some of the principles of operation of an apparatus in accordance with the present invention, an apparatus will be described.

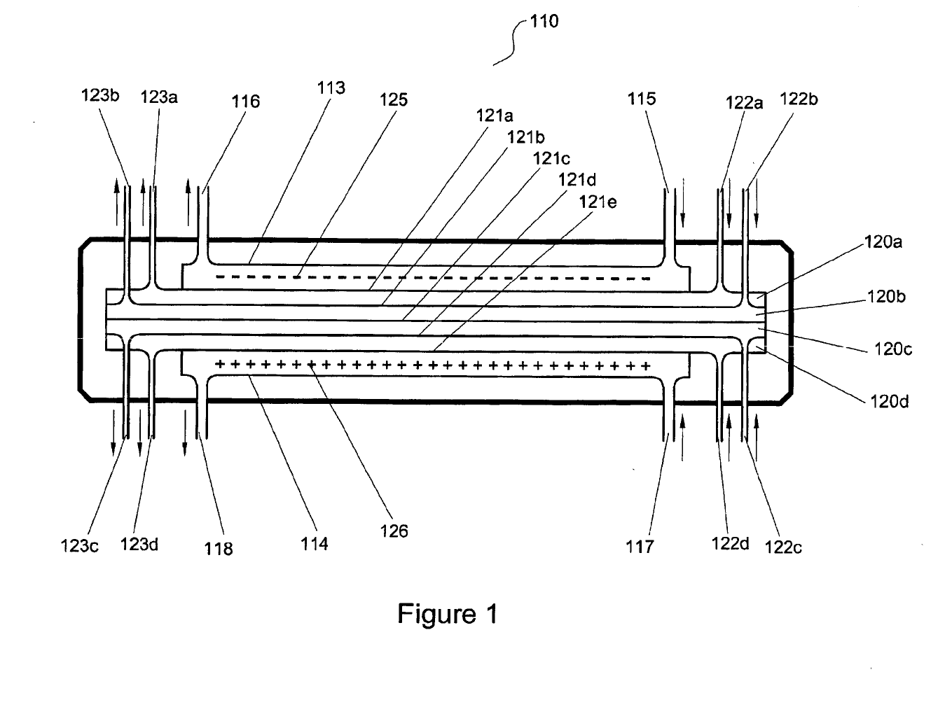

FIG. 1 shows one embodiment of an electrophoresis separation unit suitable for the apparatus according to the present invention having four separation chambers. The apparatus 110 comprises a cathode chamber 113 and an anode chamber 114, each chamber having inlet 115, 117 and outlet 116, 118 means for feeding electrolyte into and out of the respective electrode chambers 113, 114. Four separation chambers 120a, 120b, 120c, 120d, formed by five of ion-permeable barriers 121a, 121b, 121c, 121d, 121e are positioned between the cathode and anode chambers 113, 114. Four inlet 122a, 122b, 122c, 122d and four outlet 123a, 123b, 123c, 123d means for feeding liquid into and out of the respective separation chambers 120a, 120b, 120c, 120d are positioned near each end of the unit 110.

FIG. 1 shows fluids entering each of the separation chambers from the same general location and direction and fluids exiting the separation chambers from the same general location and direction. It is understood, however, that in an alternative embodiment, fluids suitably enter generally at a distal end of at least one of the chambers, from a location and a direction generally opposite at least one of the other separation chambers and fluids exit generally at a distal end of the at least one separation chamber from a location and direction generally opposite at least one of the other separation chambers such that the flow directions in the two chambers are anti-parallel.

The separation chambers 120a, 120b, 120c, 120d are suitably formed or housed in a cartridge which is adapted to be removable from the unit 110. Cathode and anode 125, 126 are housed in the anode and cathode chambers 113, 114 such that when an electric potential is applied between the electrodes, contents in the chambers are exposed to the electric potential.

When electrolyte is passed into and out of the electrode chambers 113, 114 via inlets 115, 117 and outlets 116, 118, fluid streams are formed in the respective chambers. Similarly, when fluid is passed into and out of the separation chambers 120a, 120c, 120c, 120d via inlets 122a, 122b, 122c, 122d and outlets 123a, 123b, 123c, 123d, fluid streams are formed in the respective chambers.

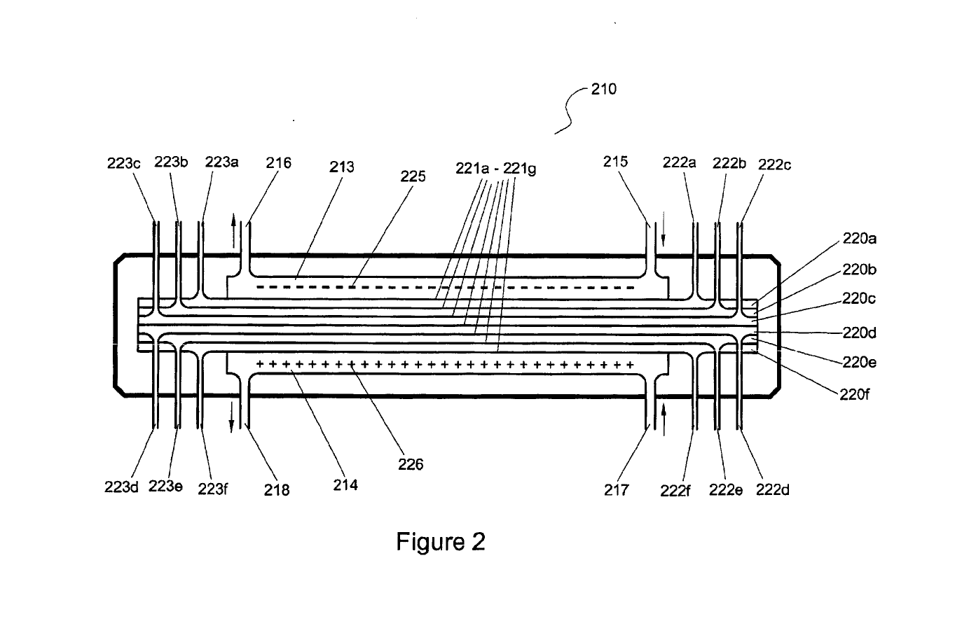

FIG. 2 shows another embodiment of a separation unit suitable for the apparatus according to the present invention having six separation chambers. The apparatus 210 comprises a cathode chamber 213 and an anode chamber 214, each chamber having inlet 215, 217 and outlet 216, 218 means for feeding electrolyte into and out of the respective electrode chambers 213, 214. Positioned between the electrode chambers 213, 214 are six separation chambers 220a, 220b, 220c, 220d, 220e, 220f formed by seven ion-permeable barriers 221a-121g positioned between the cathode and anode chambers 213, 214 forming the separation chambers 220a-220f Six inlet 222a, 222b, 222c, 222d, 222e 222f and six outlet 223a, 223b, 223c, 223d, 223e, 223f means for feeding liquid into and out of the respective separation chambers 220a-220f are positioned near each end of the unit 210.

FIG. 2 shows fluids entering each of the separation chambers from the same general location and direction and fluids exiting the separation chambers from the same general location and direction. It is understood, however, that in an alternative embodiment, fluids suitably enter generally at a distal end of at least one of the chambers, from a location and a direction generally opposite at least one of the other separation chambers and fluids exit generally at a distal end of the at least one separation chamber from a location and direction generally opposite at least one of the other separation chambers such that the flow directions in the two chambers are anti-parallel.

The separation chambers 220a-220f are suitably formed or housed in a cartridge which is adapted to be removable from the unit 210. Cathode and anode 225, 226 are housed in the anode and cathode chambers 213, 214 such that when an electric potential is applied between the electrodes 225, 226 contents in the separation chambers 220a-220f are exposed to the potential.

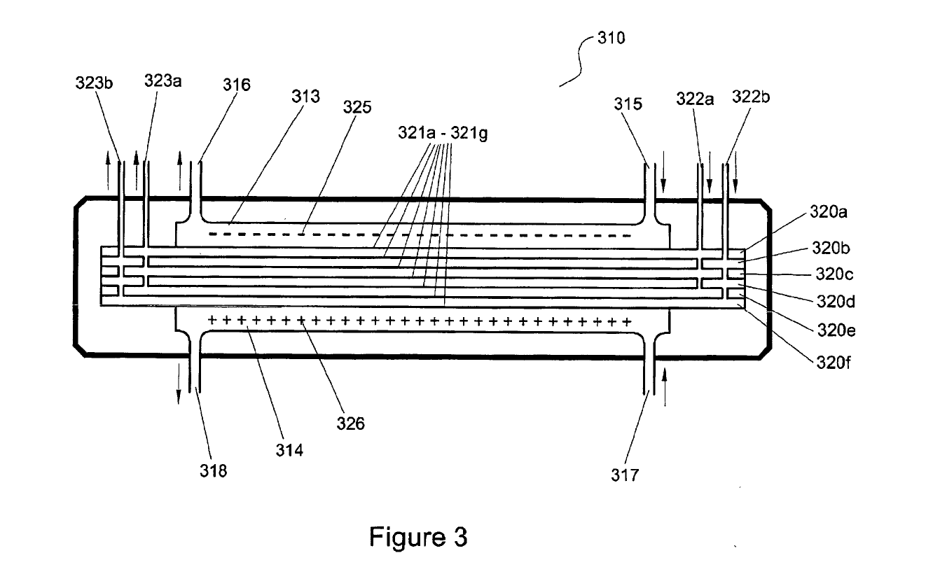

The apparatus depicted in FIG. 2 has the inlet and outlet means of each separation chamber 220a-220f fluidly separated from each other. In contrast, FIG. 3 depicts an apparatus 310 with six separation chambers 320a, 320b, 320c, 320d, 320e, 320f of which three chambers 320a, 320c, 320e are in fluid connection by common inlet 322a and common outlet 323a means. The other three separation chambers 320b, 320d, 320f are in fluid connection by common inlet 322b and common outlet 323b means. When fluid is passed into inlet means 322a and out of outlet means 323a, fluid passes through separation chambers 320a, 320c, 320e forming a separation stream in the chambers. Similarly, when fluid is passed into inlet means 322b and out of outlet means 323b, fluid passes through separation chambers 320b, 320c, 320f forming a separation stream in those chambers.

FIG. 3 shows fluids entering the separation chambers from the same general location and direction and fluids exiting the separation chambers from the same general location and direction. It is understood, however, that in an alternative embodiment, fluids suitably enter generally at a distal end of at least one of the chambers, from a location and a direction generally opposite at least one of the other separation chambers and fluids exit generally at a distal end of the at least one separation chamber from a location and direction generally opposite at least one of the other separation chambers such that the flow directions in the two chambers are anti-parallel.

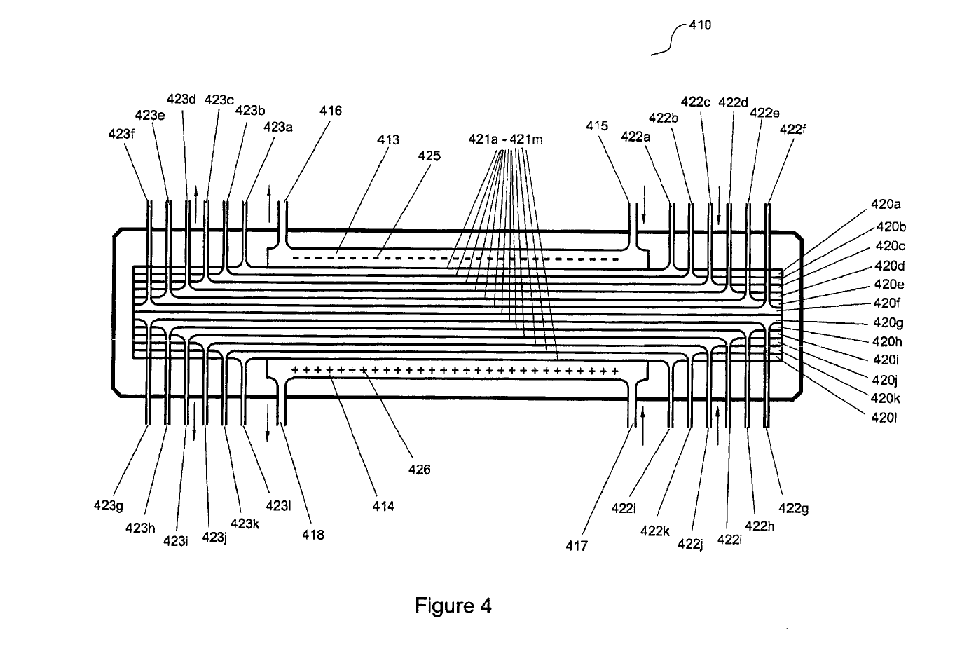

FIG. 4 shows another embodiment of the apparatus according to the present invention having twelve separation chambers. The apparatus 410 comprises a cathode chamber 413 and an anode chamber 414, each chamber having inlet 415, 417 and outlet 416, 418 means for feeding electrolyte into and out of the electrode chambers 413, 414. Twelve separation chambers 420a-420l are positioned between the cathode and anode chambers 413, 414. The separation chambers 420a-420l are formed by thirteen ion-permeable barriers 421a-421m positioned between the cathode and anode chambers 413, 414. Twelve inlet 422a-422l and twelve outlet 423a-423l means are positioned relative to each end of the unit 410 for feeding liquid into and out of the respective twelve separation chambers 420a-420l.

FIG. 4 shows fluids entering each of the separation chambers from the same general location and direction and fluids exiting the separation chambers from the same general location and direction. It is understood, however, that in an alternative embodiment, fluids suitably enter generally at a distal end of at least one of the chambers, from a location and a direction generally opposite at least one of the other separation chambers and fluids exit generally at a distal end of the at least one separation chamber from a location and direction generally opposite at least one of the other separation chambers such that the flow directions in the two chambers are anti-parallel.

The separation chambers 420a-420l are suitably formed or housed in a cartridge which is adapted to be removable from the apparatus 410. Cathode and anode 425, 426 are housed in the anode and cathode chambers 413, 414.

The apparatus depicted in FIG. 4 has each separation chamber 420a-420l fluidly separated from each other. It will be appreciated, however, that one or more chambers can share the same inlet and outlet means so that the same material may be passed through more than one separation chamber if required.

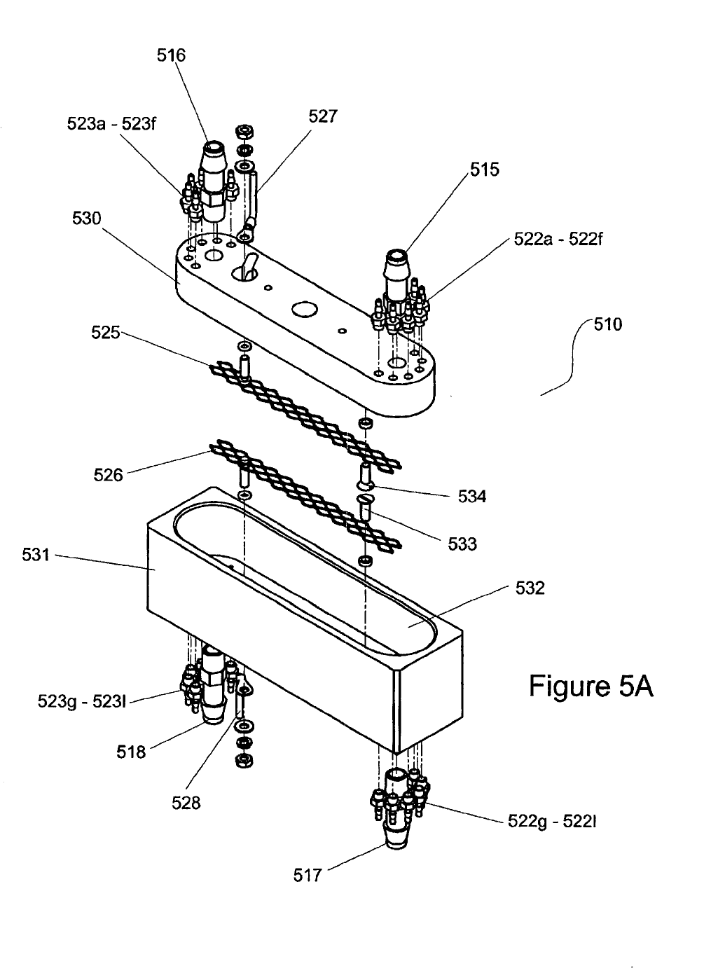

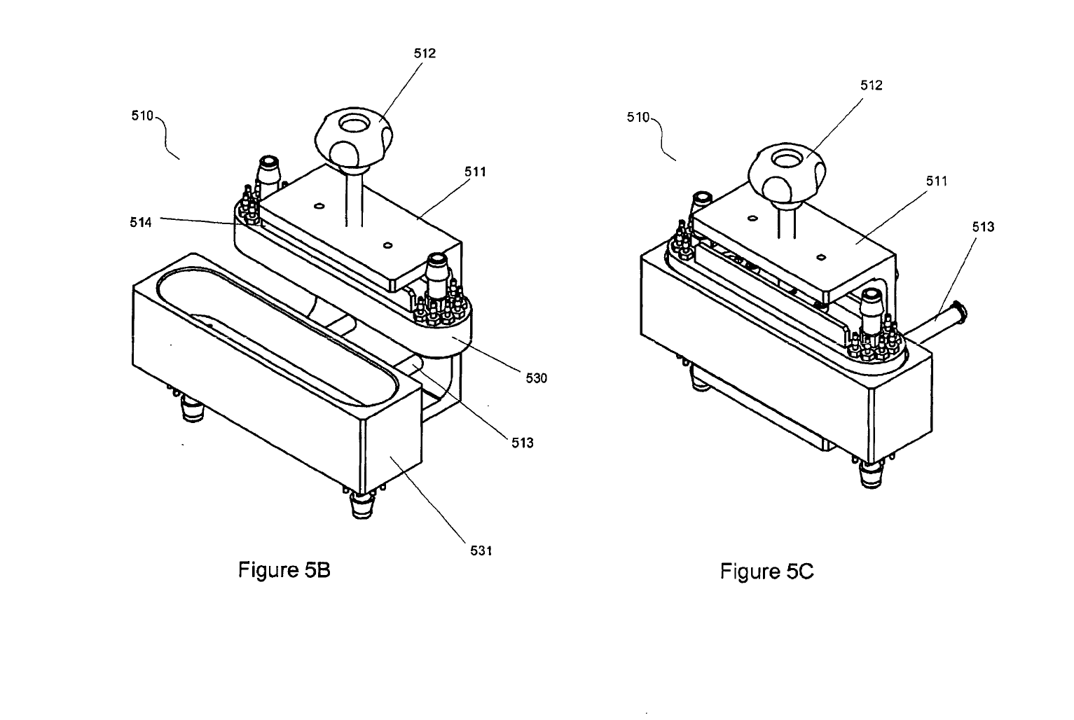

FIG. 5A shows an exploded view of a separation unit adapted to house thirteen ion-permeable barriers forming twelve separation chambers. The unit 510 includes a cathodic connection block 530 which defines six inlet 522a-522f and outlet 523a-523f means for feeding liquid into and out of six upper separation chambers and housing cathode 525. An anodic connection block 531 defines six lower inlet 522g-522l and outlet 523g-523l means for feeding liquid into and out of six lower separation chambers and housing anode 526 in the anodic connection block 531. The unit 510 has catholyte inlet 515 and outlet 516 means in the cathodic connection block 530 to pass electrolyte through the block 530 which houses a cathode. Similarly, the anodic block 531 has anolyte inlet 517 and outlet 518 means for passing electrolyte through the anodic block which houses an anode.

FIG. 5A shows fluids entering the separation chambers from the same general location and direction and fluids exiting the separation chambers from the same general location and direction. It is understood, however, that in an alternative embodiment, fluids suitably enter generally at a distal end of at least one of the chambers, from a location and a direction generally opposite at least one of the other separation chambers and fluids exit generally at a distal end of the at least one separation chamber from a location and direction generally opposite at least one of the other separation chambers such that the flow directions in the two chambers are anti-parallel.

The cathodic and anodic connection blocks 530, 531 house electrodes 525, 526 and connection means 527, 528 for connecting the electrodes to a power supply. The cathode is housed in a recess or channel defined in the cathode connection block and the anode is housed in a recess or channel defined in the anode connection block. The electrodes 525, 526 are usually made of titanium mesh coated with platinum, but other inert electrically-conducting materials would also be suitable. The anode 526 is attached to the anode block 531 by suitable attaching means such as screws 533. Similarly, the cathode is attached to the cathode block by suitable attaching means such as screws 534.

The anode connection block 531 contains recess 532 for receiving ion-permeable barriers and cathode connection block 530. Barriers are layered into the recess 532 forming an anode chamber and the required number of separation chambers. When the cathode block is placed in the recess containing the barriers, the cathode chamber is also formed.

FIG. 5B shows the separation unit 510 partially assembled in a U-shaped housing 511. The cathode block 530 is placed in housing 511 and a threaded bolt 512 passes through the housing and threaded into a plate 514 positioned on the top of the cathode block 530. Attachment means 513 is provided for the anode block 531 to ensure the unit 510 is correctly positioned in the housing 511.

FIG. 5C shows the separation unit 510 fully assembled in the housing 511. The threaded bolt 512 is tightened forcing the cathode block into the anode block sandwiching the barriers.

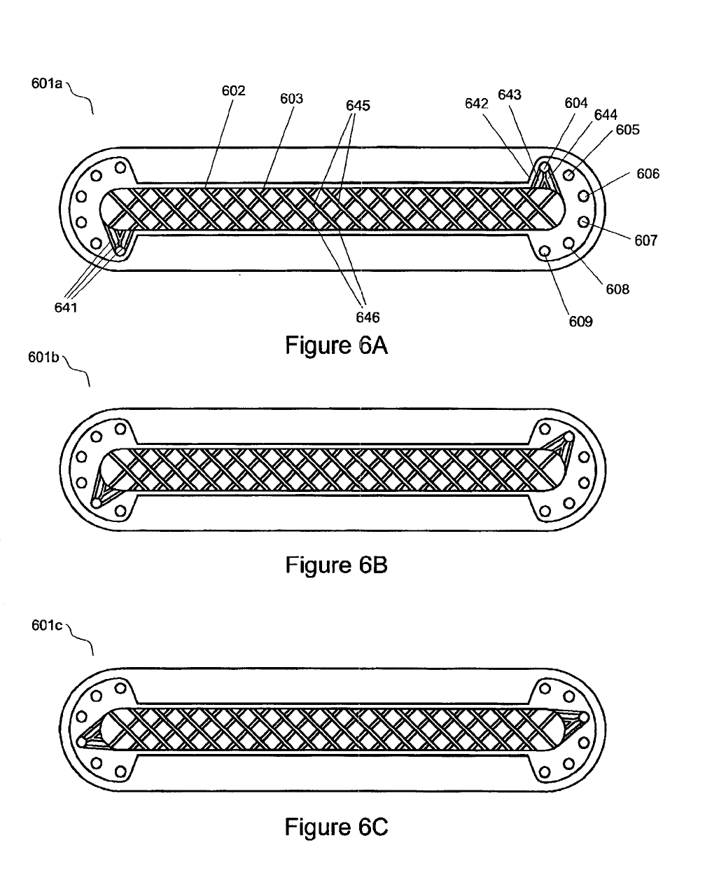

FIGS. 6A, 6B and 6C show preferred grid elements 601a, 601b, 601c respectively which, when assembled in the separation unit or a cartridge adapted to be placed in a separation unit according to the present invention, assist in supporting the ion-permeable barriers which form the electrode and separation chambers.

FIG. 6A shows a plan view of a preferred grid element 601a which is incorporated as a component of separation unit 10. An elongate rectangular cut-out portion 602 which incorporates lattice 603 is defined in the center of the grid element 601a. At each end of the grid element 601a, there is positioned six ports 604, 605, 606, 607, 608, 609 suitably provided for alignment with other components of separation unit 10. Preferably, at one port at each end there is a triangular channel area 641 having sides and a base, which extends and diverges from the associated port 604 to cut-out portion 602. Upstanding ribs 642, 643 and 644 are defined in channel area 641. Liquid flowing through port 604 thus passes along triangular channel area 641 between ribs 642, 643 and 644 and into lattice 603. Ribs 642, 643 and 644 direct the flow of liquid from port 604 so that they help ensure that liquid is evenly distributed along the cross-section of lattice 603. Ribs 642, 643 and 644 also provide support to an ion-permeable barrier disposed above or below the grid element.

Lattice 603 comprises a first array of spaced parallel members 645 extending at an angle to the longitudinal axis of the grid disposed above and integrally formed with a second lower set of spaced parallel members 646 extending at approximately twice the angle of the first array of parallel members 645 to the longitudinal axis of the grid. In the presently preferred embodiment, the first array of parallel members 645 extend at approximately a 45 degree angle from the longitudinal axis and the second array of parallel members 646 extend at approximately 90 degrees to the first array of parallel members 645, however, other angles are also suitably used.

The other ports, 605, 606, 607, 608, 609 do not have the rib configuration as in port 604 in grid 601a but are positioned to also allow flow of fluid to a separation chamber 20 other than the chamber that port 604 is in fluid communication. A second grid 601b is shown in FIG. 6B where the equivalent port 605 of grid 601a contains the rib arrangement 642, 643 and 644 for assisting the flow of fluid into the chamber that is in fluid communication with grid 601b. Similarly, FIG. 6C shows a third grid 601c where the equivalent port 606 of grid 601a contains the rib arrangement 642, 643 and 644 for assisting the flow of fluid into the chamber that is in fluid communication with grid 601c. Depending on the number of grids and ion-permeable barriers used and the orientation of the grids assembled in a unit, a plurality of separation chambers are suitably formed which can be isolated fluidly from each other or may be in fluid communication with two or more separation chambers.

The thickness of the grid element is preferably relatively small. In one presently preferred embodiment, exterior areas of the grid element are 0.8 mm thick. A sealing rib or ridge can extend around the periphery of lattice 603 to improve sealing on the reverse side of the grid element. The ridge is preferably approximately 1.2 mm thick measured from one side of the grid element to the other. The distance between the opposite peaks of lattice elements 645 and 646 measured from one side of the grid to the other is preferably approximately 1 mm. The relatively small thickness of the grid provides several advantages. First, it results in a more even distribution of liquid over ion-permeable barrier 21 and assists in inhibiting its fouling by macromolecules.

Also, the volume of liquid required is decreased by the use of a relatively thin grid which enables relatively small sample volumes to be used for laboratory-scale separations, a significant advantage over prior art separation devices.

Finally, if the electric field strength is maintained constant, the use of a relatively thinner grid element enables less electrical power to be deposited into the liquid. If less heat is transferred into the liquid, the temperature of the liquid remains lower. This is advantageous since high temperatures may destroy both the sample and the desired product.

The separation unit suitably houses a cartridge or cassette and includes an anodic connection block and a cathodic connection block between which, in use, the cartridge is clamped.

The cartridge comprises a cartridge housing which holds the components of the cartridge such as grid elements 601 and ion-permeable barriers 21. The cartridge is generally elongate and includes two parallel elongate side walls which extend along the longitudinal axis A-A of the cartridge. Each end of the cartridge includes end walls so that the cartridge is generally oval in plan view. A small flange extends around the base of the walls. The flange projects inwards towards the center of the cartridge. Optionally, planar silicon rubber gaskets whose exterior is generally oval are configured to fit inside the walls of the cartridge resting on the flange to assist in sealing the components. If used, the center of the gasket defines an elongate cut out portion. Adjacent to either end of the seal there are a number of holes, depending on the number of separation chambers provided in the cartridge.

Above the gasket is located an ion-permeable barrier whose external shape is generally the same as that of the interior of the cartridge, so that it too fits inside the cartridge. Each barrier has several holes adjacent to either end of the membrane and positioned so that when the cartridge is assembled, those holes align with the holes of the gasket.

Above the first barrier there is a grid element. Above that grid element is a second barrier. More grid elements are stacked with corresponding barriers positioned in between to provide the number of separation chambers required.

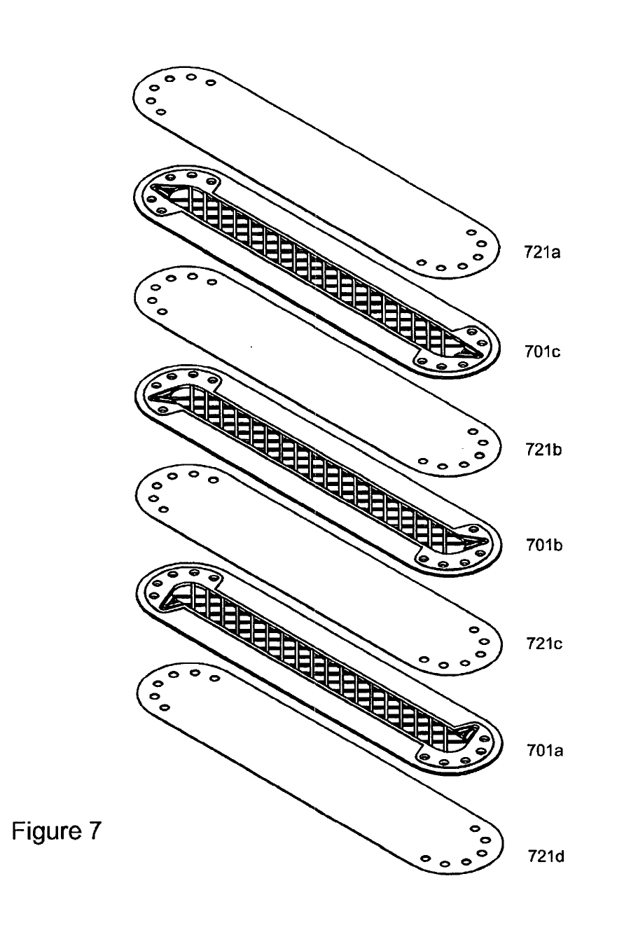

Examples of stacking arrangement of grid elements and ion-permeable barriers are shown in FIGS. 7 to 10. FIG. 7 shows exploded view of an arrangement forming three separation chambers. The unit contains four barriers 721a-721d and three grid elements 701c, 701b, 701a. Barrier 721a is positioned at the cathode side of the separation unit and is supported by grid element 701c. A first separation chamber is formed between barrier 721a and element 701c. A second barrier 721b is positioned between grid elements 701c and 701b such that a second sample chamber is formed between barrier 721b and grid element 701b. Third barrier 721c is positioned between the grid elements 701b and 701a forming a third sample chamber between the third barrier 721c and grid element 701a. Fourth barrier 721d is positioned at the anode side of the separation unit.

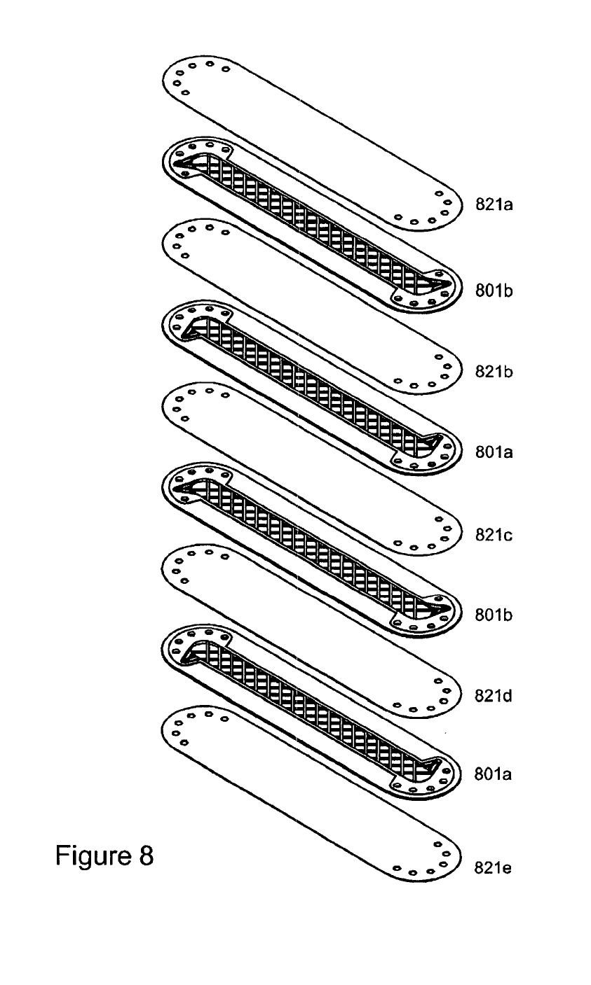

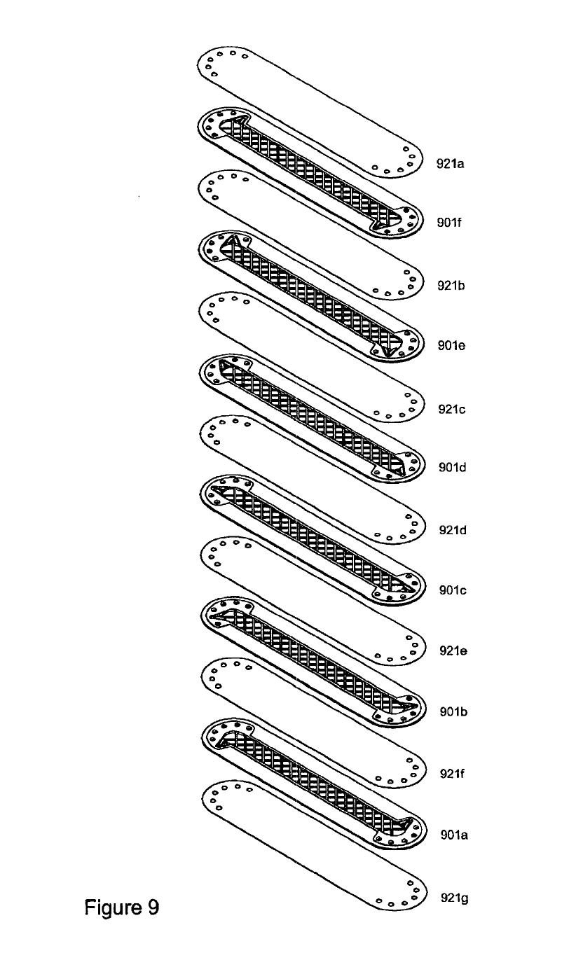

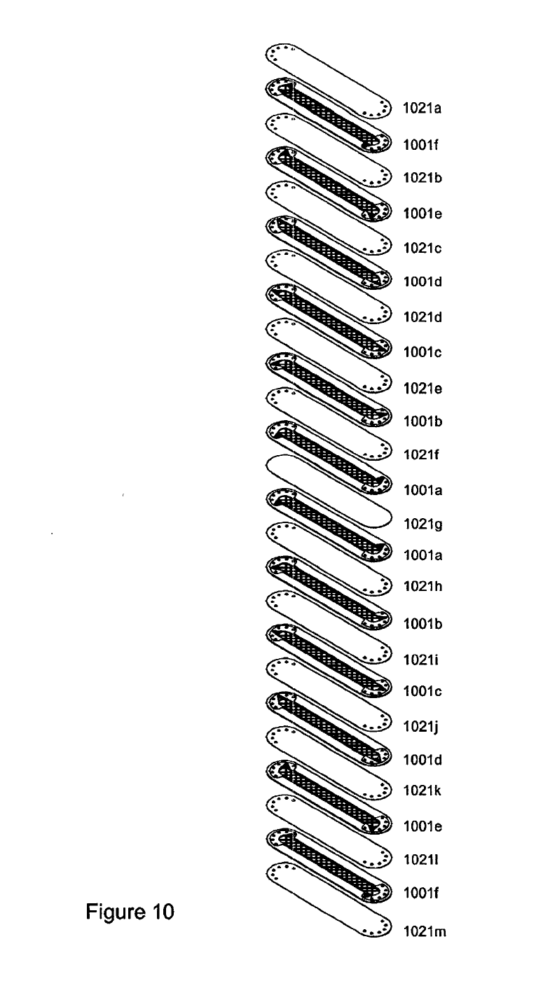

In a similar arrangement, FIG. 8 shows an exploded view of an arrangement of barriers and grid elements forming four separation chambers. The unit contains five barriers 821a-821e and four grid elements 801d, 801c, 801b, 801a. FIG. 9 shows an exploded view of an arrangement of barriers and grid elements forming six separation chambers. The unit contains seven barriers 921a-921g and six grid elements 901a, 901b, 901, 901d, 901e, 901f. FIG. 10 shows an exploded view of an arrangement of barriers and grid elements forming twelve separation chambers. The unit contains thirteen barriers 1021a-1021m and twelve grid elements 1001a, 1001b, 1001c, 1001d, 1001e, 1001f. It will be appreciated from the examples provided that the modular approach of the present invention using barriers and grid elements allows the preparation of many different arrangements.

One function of the grid element is to keep the barriers apart. The grid element also has to provide a path for the sample or electrolyte flow in each separation chamber since the grid elements for each chamber are similar. The grid element is generally planar and the exterior of the grid element is shaped to fit inside the walls of the cartridge housing.

The ion-permeable barrier is selected depending on the application. Following each separation barrier there are preferably further elements. These include a further grid element, an ion-permeable barrier, and a further gasket symmetrically arranged about the barrier. Those stacked components form the separation chamber and a part of the boundary of the electrode chamber stream. The components are held in the cartridge by means of a clip or screw or some other suitable fastener.

The main function of the cartridge is to hold the components together for insertion into the separation unit. The actual cartridge walls may have no effect on the sealing of the apparatus. If the apparatus is correctly sealed, no liquid should contact the walls of the cartridge in use.

The cathode and anode are suitably formed from platinum coated titanium expanded mesh, in contrast with the standard electrodes usually used for electrolytic cells which comprise platinum wire. The platinum coated titanium expanded mesh used in the apparatus of the present invention has several advantages over platinum wire. In particular, the ridged structure is self supporting and less expensive than platinum wire. The mesh also provides a greater surface area and allows lower current densities on the electrode surfaces. Also, the larger surface area distributed over the electrolyte channel provides a more even electrical field for the separation process.

The electrodes are also located close to the adjacent ion-permeable barriers. Therefore, less of the applied potential drops across the layers of the anolyte and the catholyte, and less heating of the liquid occurs. Connectors from the electrodes pass to sockets for connection of electrical power to the electrodes. The electrodes are shrouded to prevent accidental contact with an operator's fingers or the like.

In use, the cartridge is loaded into the unit, or alternatively the barriers and grid elements assembled in the unit, jaws forming a locking arrangement are closed to seal the components in place, the electrolyte solutions and samples are fed through the connection blocks via the appropriate inlet and outlet means. The unit is connected to an electrophoresis apparatus which includes pumps, plumbing and cooling provisions, if required. Connection is also made to a power supply in order to provide the electric potential for a given separation. The electric potential is set to the desired value and separation carried out as required. After the separation has been carried out, the cartridge may be reused, removed or replaced with a fresh cartridge. Alternatively, the barriers and grid elements can be reused or disassembled from the unit. Tubing connecting the inlet and outlet means may be cleaned and the electrolyte replaced, if necessary. Following that, the unit is ready to carry out a further separation.

The electrolyte solution provides the required conductivity, may also stabilize the pH during separation and act as the cooling medium.

The design of the separation unit is easily adaptable for a multi-channel separation unit and apparatus with up to twelve chambers. More separation chambers can be accommodated but this increases the complexity of the arrangement regarding plumbing and pumping fluid to the chambers. For excellent flexibility, the present inventors developed a new grid design which could be expanded to accommodate a variable number of extra separation chambers. In one form, the new design allows up to twelve separation chambers (plus, the two electrode chambers) having six similar but distinct grids having six holes in each end. Twelve sample chambers are formed by stacking two sets of six grids placed in an apparatus having up to twelve different sets of fluid connections. In one form, there are three similar but distinct grids with three holes in each end to enable three different sets of connections. The grids can be stacked to form six separation chambers. The design allows the convenient formation of up to twelve separation chambers.

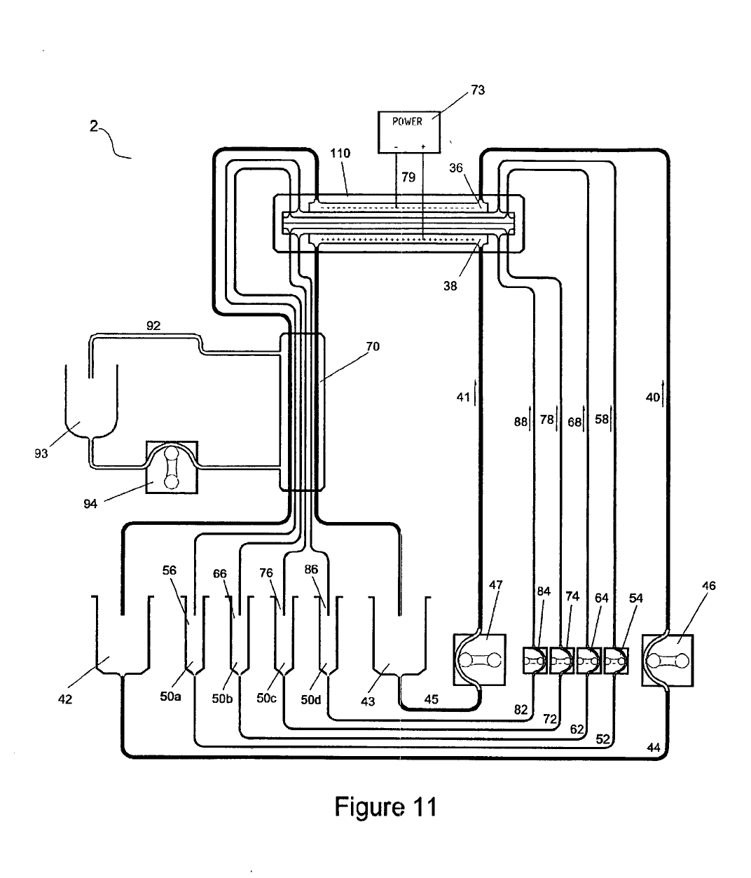

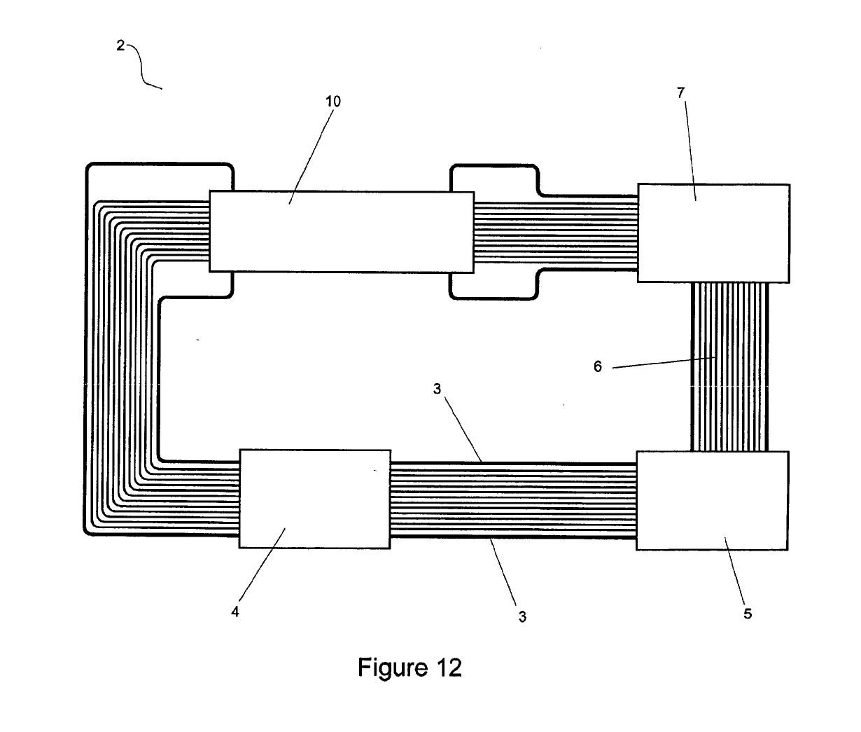

A schematic diagram of an electrophoresis apparatus 2 utilizing a separation unit 110 of FIG. 1 is shown in FIG. 11 for the purpose of illustrating the general functionality of an apparatus utilizing the technology of the present invention. In this purely illustrative example, six chambers (cathodic chamber 113, anodic chamber 114, and four separation chambers 120a-120d) are connected to six flow circuits. First electrolyte flow circuit 40 comprises first electrolyte reservoir 42, electrolyte tubing 44, and electrolyte pump 46. Second electrolyte flow circuit 41 comprises second electrolyte reservoir 43, electrolyte tubing 45, and electrolyte pump 47. In the configuration shown in FIG. 11, electrolyte flow circuits 40 and 41 are running independently from each other so that the composition, temperature, flow rate and volume of first electrolyte 36 and second electrolyte 38 can be suitably adjusted independently of one another.

In the embodiment shown, first electrolyte 36 flows from first electrolyte reservoir 42 through tubing 44 to pump 46 to first electrolyte chamber 113. Second electrolyte 38 flows from second electrolyte reservoir 43 through tubing 45 to pump 47 to second electrolyte chamber 114. First electrolyte 36 flows through inlet 115 and second electrolyte 38 flows through inlet 117. First electrolyte 36 exits separation unit 110 through outlet 116 and second electrolyte 38 exits separation unit 110 through outlet 118. After exiting separation unit 110, electrolytes 36 and 38 flow through tubing 44 and 45 back into respective electrolyte reservoirs 42 and 43. In one embodiment, electrolytes 36 and 38 are held stagnant in electrolyte chambers 113 and 114 during separation. Electrolytes 36 and 38 suitably also act as a cooling medium and help prevent a build up of gases generated during electrophoresis.

First separation flow circuit 58 contains first sample reservoir 50a, tubing 52 and pump 54. First sample 56 flows from first sample reservoir 50a through tubing 52 to pump 54, then through inlet 122a into first separation chamber 120a. In one embodiment, the flow directions of first sample 56 and electrolytes 36 and 38 in first sample chamber 120a are opposite. First sample 56 exits separation unit 110 at outlet 123a and flows through tubing 52, then heat exchanger 70 before returning to first sample reservoir 50a through tubing 52. In an alternative embodiment, heat exchanger 70 passes through first electrolyte reservoir 42. In another embodiment, the flow directions of first sample 56 and electrolytes 36 and 38 in first separation chamber 120a are the same.

In addition to components of interest, first sample 56 may contain any suitable electrolyte or additive known in the art as demanded by the procedure, application, or separation being performed to substantially prevent or cause migration of selected components through the ion-permeable barriers. In a preferred embodiment, sample from which constituents are removed is placed into first sample reservoir 50a. However, it is understood that in an alternative embodiment, sample from which constituents are removed is placed into second sample reservoir 50b.

Similarly, second sample flow circuit 68 contains second sample reservoir 50b, tubing 62 and pump 64. Second sample 66 flows from second sample reservoir 50b through tubing 62 to pump 64, then through inlet 122b into second separation chamber 120b. In one embodiment, the flow directions of second sample 66 and electrolytes 36 and 38 in second separation chamber 120b are opposite. Second sample 66 exits separation unit 110 at outlet 123b and flows through tubing 62, to heat exchanger 70 before returning to second sample reservoir 50b through tubing 62. In an alternative embodiment, heat exchanger 70 passes through first electrolyte reservoir 42 or second electrolyte reservoir 43.

Second sample 66 may contain any suitable electrolyte or additive known in the art as demanded by the procedure, application, or separation being performed to substantially prevent or cause migration of selected components through the ion-permeable barriers. In a preferred embodiment, sample from which constituents are removed is placed into second sample reservoir 50b. However, it is understood that in an alternative embodiment, sample from which constituents are removed is placed into first sample reservoir 50a.

Similarly, third sample flow circuit 78 contains third sample reservoir 50c, tubing 72 and pump 74. Third sample 76 flows from third sample reservoir 50c through tubing 72 to pump 74, then through inlet 122c into third separation chamber 120c. In one embodiment, the flow directions of third sample 76 and electrolytes 36 and 38 in third separation chamber 120c are opposite. Third sample 76 exits separation unit 110 at outlet 123c and flows through tubing 72, to heat exchanger 70 before returning to third sample reservoir 50c through tubing 72. In an alternative embodiment, heat exchanger 70 passes through first electrolyte reservoir 42 or second electrolyte reservoir 43.

Third sample 76 may contain any suitable electrolyte or additive known in the art as demanded by the procedure, application, or separation being performed to substantially prevent or cause migration of selected components through the ion-permeable barriers. In a preferred embodiment, sample from which constituents are removed is placed into third sample reservoir 50c. However, it is understood that in an alternative embodiment, sample from which constituents are removed is placed into first sample reservoir 50a, or second sample reservoir 50b.

Similarly, fourth sample flow circuit 88 contains fourth sample reservoir 50d, tubing 82 and pump 84. Fourth sample 86 flows from fourth sample reservoir 50d through tubing 82 to pump 84, then through inlet 122d into fourth separation chamber 120d. In one embodiment, the flow directions of fourth sample 86 and electrolytes 36 and 38 in second separation chamber 120d are opposite. Fourth sample 86 exits separation unit 110 at outlet 123d and flows through tubing 82, to heat exchanger 70 before returning to fourth sample reservoir 50d through tubing 82. In an alternative embodiment, heat exchanger 70 passes through first electrolyte reservoir 42 or second electrolyte reservoir 43.

Fourth sample 86 may contain any suitable electrolyte or additive known in the art as demanded by the procedure, application, or separation being performed to substantially prevent or cause migration of selected components through the ion-permeable barriers. In a preferred embodiment, sample from which constituents are removed is placed into third sample reservoir 50c. However, it is understood that in an alternative embodiment, sample from which constituents are removed is placed into first sample reservoir 50a or the second sample reservoir 50b.

The heat exchanger 70 is preferably a tube-in-shell apparatus having pump 94 which passes cooled fluid via tubing 92 from reservoir 93 through the exchanger 70. As fluid is passed through the heat exchanger 70 in its respective tubing, the contents is suitably cooled to the desired temperature.

Individually adjustable flow rates of first sample 56, second sample 66, third sample 76, fourth sample 86, first electrolyte 42 and second electrolyte 43, when employed, can have a significant influence on the separation. Flow rates ranging from zero through several milliliters per minute to several liters per minute are suitable depending on the configuration of the apparatus and the composition, amount and volume of sample processed. In a laboratory scale instrument, individually adjustable flow rates ranging from about 0 mL/minute to about 50,000 mL/minute are used, with the preferred flow rates in the 0 mL/min to about 1,000 mL/minute range. However, higher flow rates are also possible, depending on the pumping means and size of the apparatus. Selection of the individually adjustable flow rates is dependent on the process, the component or components to be transferred, efficiency of transfer, and coupling of the process with other, preceding or following processes.

Furthermore, it is preferable that sample flow circuits 58, 68, 78, and 88, first electrolyte flow circuit 40 and second electrolyte flow circuit 41 are completely enclosed to prevent contamination or cross-contamination. In a preferred embodiment, reservoirs 50a-50d, 42, and 43 are completely and individually enclosed from the rest of the apparatus.

The separation unit further comprises electrodes 125 and 126. Preferably, the respective electrodes are located in the first and second electrolyte chambers 113, 114 and are separated from the first and second sample chambers by ion-permeable barriers.

Electrodes 125 and 126 are suitably standard electrodes or preferably are formed from platinum coated titanium expanded mesh, providing favorable mechanical properties, even distribution of the electric field, long service life and cost efficiency. Electrodes 125 and 126 are preferably located relatively close to ion-permeable barriers 121a and 121e providing better utilization of the applied potential and diminished heat generation. A distance of about 0.1 to 6 mm has been found to be suitable for a laboratory scale apparatus. For scaled-up versions, the distance will depend on the number and type of ion-permeable barriers, and the size and volume of the electrolyte and sample chambers. Preferred distances would be in the order of about 0.1 mm to about 10 mm.

Separation unit 110 also preferably comprises electrode connectors 79 that are used for connecting separation unit 110 to power supply 73. Preferably, power supply 73 is external to separation unit, however, separation unit 110 is configurable to accept internal power supply 73.

Separation is achieved when an electric potential is applied to separation unit 110. Selection of the electric field strength (potential) varies depending on the separation. Typically, the electric field strength varies between 1 V/cm to about 5,000 V/cm, preferably between 10 V/cm to 2,000 V/cm. It is preferable to maintain the total power consumption in the unit at the minimum, commensurable with the desired separation and production rate.

In one embodiment, the applied electric potential is periodically stopped and reversed to cause movement of components that have entered the ion-permeable barriers back into at least one of the fluid streams, while substantially not causing re-entry of any components that have entered other fluid streams. In another embodiment, a resting period is utilized. Resting (a period during which fluid flows are maintained but no electric potential is applied) is an optional step that suitably replaces or is included after an optional reversal of the electric potential. Resting is often used for protein-containing samples as an alternative to reversing the potential.

Separation unit 110 is suitably cooled by various methods known in the art such as ice bricks or cooling coils (external apparatus) placed in one or both electrolyte reservoirs 42 and 43, or any other suitable means capable of controlling the temperature of electrolytes 36 and 38. Because both sample flow circuits 58, 68, 78 and 88 pass through heat exchanger 70, heat is exchanged between samples and one or both of first and second electrolytes. Heat exchange tends to maintain the temperature in the samples at the preferred, usually low levels.

The present invention further encompasses an electrophoresis apparatus utilizing separation units having from three to at least twelve separation chambers as described above. For example, the separation units described with reference to FIGS. 2 to 4 can also be used with the appropriate number of flow paths, pumps, and sample chambers.

FIG. 12 shows a schematic of an electrophoresis apparatus 2 having two electrolyte flow paths 3, twelve separation flow paths 6, sample and electrolyte reservoirs 5 and a cooling facility 7. Separation unit 10 houses twelve separation chambers, cathode chamber and anode chamber. Pumps 4 communicate fluid to the separation unit 10 from the sample and electrolyte chambers 5.

An advantage of the present invention is the ability to arrange for a separation apparatus having three or more separation chambers in various configurations.

In one embodiment, an ion-permeable barrier is formed from a membrane with a characteristic average pore size and pore-size distribution. The average pore size and pore size distribution of the membrane is selected to facilitate trans-membrane transport of certain constituents, while substantially preventing trans-membrane transport of other constituents.

In another embodiment, an ion-permeable barrier is an isoelectric ion-permeable barrier, such as an isoelectric membrane that substantially prevents convective mixing of the contents of adjoining chambers, while permits selective trans-barrier transport of selected constituents upon application of the electric potential. Suitable isoelectric membranes can be produced by copolymerizing acrylamide, N,N′-methylene bisacrylamide and appropriate acrylamido derivatives of weak electrolytes yielding isoelectric membranes with pI values in the 2 to 12 range, and average pore sizes that either facilitate or substantially prevent trans-membrane transport of components of selected sizes.

In another embodiment, an ion-permeable barrier is an ion-exchange ion-permeable barrier, such as anion-exchange membrane that substantially prevents convective mixing of the contents of adjoining chambers, while permits selective trans-barrier transport of selected constituents upon application of the electric potential. Suitable ion-exchange membranes are strong-electrolyte and weak-electrolyte functional-group containing porous membranes.

### EXAMPLES

### Example 1

An apparatus according to the present invention containing twelve separation chambers was used to separate immunoglobulin G (IgG) from human plasma. This example demonstrated the use of the apparatus for processing the same feed sample, from the same sample reservoir, through four sets of identical, multiple, parallel separation chambers.

The separation unit was assembled as follows. All ion-permeable barriers were polyacrylamide membranes with different nominal molecular mass cut-offs (NMM). The first set of parallel separation chambers started with a 1^{st} ion-permeable barrier between the anode chamber and the 1^{st} separation chamber with an NMM of 5,000 dalton, through the next barrier between the 1^{st} and 2^{nd} separation chambers with an NMM of 100,000 dalton, then the next barrier between the 2^{nd} and 3^{rd} separation chambers with an NMM of greater than 1,000,000 dalton. The second set of parallel separation chambers started with the barrier between the 3^{rd} and 4^{th} separation chambers with an NMM of 5,000 dalton, through the next barrier between the 4^{th} and 5^{th} separation chambers with an NMM of 100,000 dalton, then the next barrier between the 5^{th} and 6^{th} separation chambers with an NMM of greater than 1,000,000 dalton. The third set of parallel separation chambers started with the barrier between the 6^{th} and 7^{th} separation chambers with an NMM of 5,000 dalton, through the next barrier between the 7^{th} and 8^{th} separation chambers with an NMM of 100,000 dalton, then the next barrier between the 8^{th} and 9^{th} separation chambers with an NMM of greater than 1,000,000 dalton. Finally, the fourth set of parallel separation chambers started with the barrier between the 9^{th} and 10^{th} separation chambers with an NMM of 5,000 dalton, through the next barrier between the 10^{th} and 11^{th} separation chambers with an NMM of 100,000 dalton, then the next barrier between the 11^{th} and 12^{th} separation chambers with an NMM of greater than 1,000,000 dalton. The 12^{th} separation chamber is separated from the cathode chamber by an ion-permeable barrier with an NMM of 5,000 dalton.

The electrolyte in the anode and cathode chambers (2 L each), as well as in the 1^{st}, 2^{nd}, 4^{th}, 5^{th}, 7^{th}, 8^{th}, and 10^{th}, 11^{th} separation chambers (20 mL each) was identical: 60 mM MOPS and 40 mM GABA at pH 5.50. The feed sample was prepared by diluting human plasma at a rate of 1 to 10 with the same pH 5.50, 60 mM MOPS and 40 mM GABA buffer (final pH 6.02). One hundred and ten mL of this sample was loaded into the 3^{rd}, 6^{th}, 9^{th} and 12^{th} separation chambers.

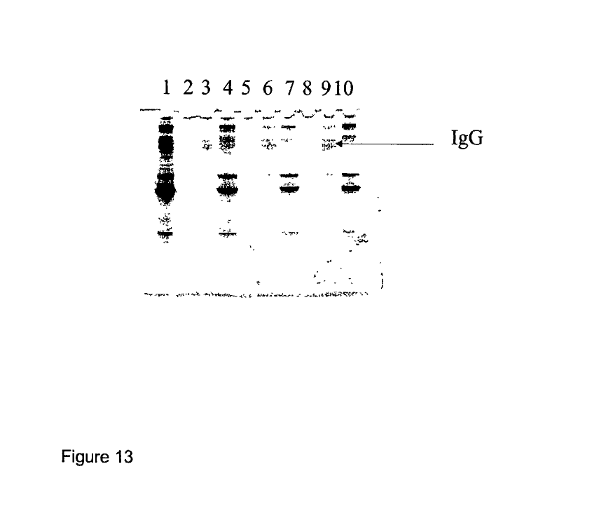

The separation was conducted at 600V for 180 min. The current was around 34 mA during the separation. At pH 5.5, IgG was cationic and moved toward the cathode, crossed the greater than 1,000,000 dalton NMM barriers, but could not cross the 100,000 dalton NMM barriers, and thus was trapped in separation chambers 2, 5, 8, and 11 as the product. The low molecular mass proteins proceeded through the NMM 100,000 barrier and were trapped in streams 1, 4, 7 and 10 (contaminant stream). Transfer of IgG from the sample stream to the product stream was evident at the first analysis point at 60 mins (FIG. 13). The pH changes observed over the course of the separation are listed in Table 1.

TABLE 1
pH changes during purification of IgG from human plasma using a
multiple membrane stack and a single sample source.

| Component | initial pH | final pH |
|---|---|---|
| Catholyte | 5.5 | 5.78 |
| Contaminant stream | 5.5 | 5.47 |
| Product stream | 5.5 | 5.49 |
| Feed stream | 6.02 | 5.48 |
| Anolyte | 5.5 | 5.39 |

### Example 2

An apparatus according to the present invention containing twelve separation chambers was used to separate IgG from human plasma. This example demonstrated the use of the apparatus for processing the same feed sample, from the same sample reservoir, through four sets of identical, multiple, parallel separation chambers using the principles of a pH-dependent charge-based separation.

The separation unit was assembled as follows. All ion-permeable barriers were polyacrylamide membranes with different nominal molecular mass cut-offs (NMM). The first set of parallel separation chambers started with the 1^{st} ion-permeable barrier between the anode chamber and the 1^{st} separation chamber with an NMM of 5,000 dalton, through the next barrier between the 1^{st} and 2^{nd} separation chambers with an NMM of greater than 1,000,000 dalton. The second set of parallel separation chambers started with the barrier between the 2^{nd} and 3^{rd} separation chambers with an NMM of 5,000 dalton, through the next barrier between the 3^{rd} and 4^{th} separation chambers with an NMM of greater than 1,000,000 dalton. The third set of parallel separation chambers started with the barrier between the 4^{th} and 5^{th} separation chambers with an NMM of 5,000 dalton, through the next barrier between the 5^{th} and 6^{th} separation chambers with an NMM of greater than 1,000,000 dalton. The fourth set of parallel separation chambers started with the barrier between the 6^{th} and 7^{th} separation chambers with an NMM of 5,000 dalton, through the next barrier between the 7^{th} and 8^{th} separation chambers with an NMM of greater than 1,000,000 dalton. The fifth set of parallel separation chambers started with the barrier between the 8^{th} and 9^{th} separation chambers with an NMM of 5,000 dalton, through the next barrier between the 9^{th} and 10^{th} separation chambers with an NMM of greater than 1,000,000 dalton. The last, sixth set of parallel separation chambers starts with the barrier between the 10^{th} and 11^{th} separation chambers with an NMM of 5,000 dalton, through the next barrier between the 11^{th} and 12^{th} separation chambers with an NMM of greater than 1,000,000 dalton. Finally, the 12^{th} separation chamber was separated from the cathode chamber by an ion-permeable barrier with an NMM of 5,000 dalton.

The electrolyte in the anode and cathode chambers (2 L each), as well as in the 1^{st}, 3^{rd}, 5^{th}, 7^{th}, 9^{th}, and 11^{th} separation chambers (15 mL each) was identical: 60 mM MOPS and 40 mM GABA at pH 5.46. The feed sample was prepared by diluting human plasma at a rate of 1 to 10 with the pH 5.46 60 mM MOPS and 40 mM GABA buffer (final pH 6.02). Fifteen mL of this sample was loaded into each of the 2^{nd}, 4^{th}, 6^{th}, 8^{th}, 10^{th}, and 12^{th} separation chambers.

The separation was conducted for 180 mins at 600V. The current was around 30 mA during the separation. At pH 5.46, IgG was cationic and moved toward the cathode, crossing the greater than 1,000,000 dalton NMM barriers. The higher pI proteins were anionic and remained where they were fed: in chambers 2^{nd}, 4^{th}, 6^{th}, 8^{th}, 10^{th}, and 12^{th}, because even though they were anionic, they could not cross the NMM 5,000 barriers. At the end of the separation, each product and sample stream was collected, and 10 mL of phosphate-buffered saline solution (PBS) was added to each stream and circulated for 10 min without applying the separation potential. The PBS solution was then collected from each stream.

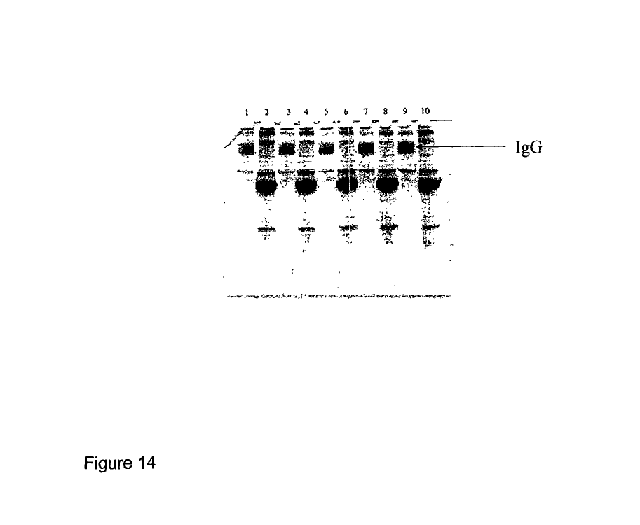

The transfer of IgG into the product streams was mostly complete at 60 mins (FIG. 14). At the end of the separation, the pH of all sample streams ranged from 5.49 to 5.55, the catholyte was pH 5.76 and the anolyte was pH 5.45.

### Example 3

An apparatus according to the present invention containing twelve separation chambers was used to separate the components of chicken egg white according to their size. This example demonstrated the use of the apparatus for achieving size-based separations through the use of a series of ion-permeable barriers whose nominal molecular mass cut-off is different.

The separation unit was assembled as follows. All ion-permeable barriers were polyacrylamide membranes with different nominal molecular mass cut-offs (NMM). The ion-permeable barrier between the anode chamber and the 1^{st} separation chamber was a polyacrylamide membrane with an NMM of 3,000 dalton. The barrier between the 1^{st} and 2^{nd} separation chambers had an NMM of 5,000 dalton, the barrier between the 2^{nd} and 3^{rd} separation chambers had an NMM of 50,000 dalton, the barrier between the 3^{rd} and 4^{th} separation chambers had an NMM of 10,000 dalton, the barrier between the 3^{rd} and 4^{th} separation chambers had an NMM of 100,000 dalton, the next barrier between the 4^{th} and 5^{th} separation chambers had an NMM of 150,000 dalton, the next barrier between the 5^{th} and 6^{th} separation chambers had an NMM of 200,000 dalton. The next barrier between the 6^{th} and 7^{th} separation chambers had an NMM of 300,000 dalton, the next barrier between the 7^{th} and 8^{th} separation chambers had an NMM of 400,000 dalton. The 8^{th} and 9^{th} chambers were separated by an NMM 500,000 dalton barrier. The 9^{th} and 10^{th} separation chambers and the 10^{th} and 11^{th} separation chambers were separated by 1,000,000 dalton NMM membranes. The barrier between the 11^{th} and 12^{th} separation chambers had an NMM of 15,000 dalton. The 12^{th} separation chamber was separated from the cathode chamber by an ion-permeable barrier with an NMM of 3,000 dalton.

The electrolyte in the anode and cathode chambers (2 L each), as well as in the 1^{st}, 2^{nd}, 3^{rd}, 4^{th}, 5^{th}, 6^{th}, 7^{th}, 8^{th}, 9^{th}, 11^{th} and 12^{th} separation chambers (20 ML each) was identical: 90 mM Tris, 90 mM borate, 1 mM EDTA at pH 8.51 (TBE). The feed sample was prepared by diluting 15 mL egg white, at a rate of 1 to 4, with the electrolyte used in all the chambers and filtered through polyethylene terephthalate paper. Forty mL of this sample solution was loaded into the sample reservoir connected to separation chamber 10. The separation was conducted at 600 V for 4 hours.

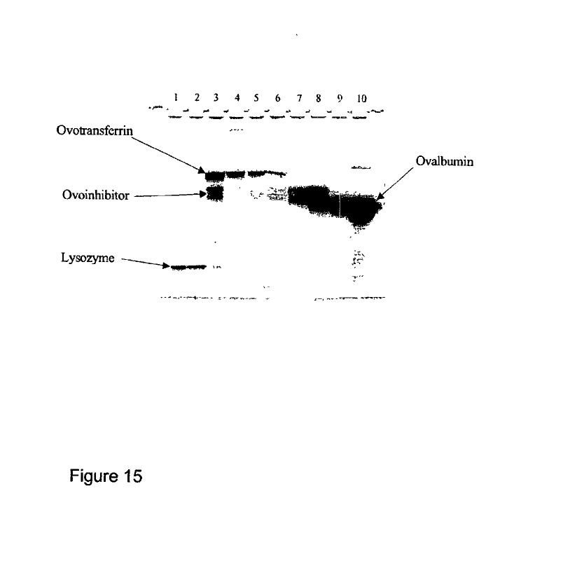

FIG. 15 shows the image of an SDS-PAGE separation of the contents of the separation chambers after 4 hours of electrolysis. Lysozyme from egg white (molecular mass 14 kDa, isoelectric point of 10) moved into separation chambers 11 and 12 (between the 3 kDa-15 kDa and 15 kDa-1000 kDa membranes), because this protein is positively charged at pH 8.5 (Lanes 1 and 2). Negatively charged proteins moved toward the anode (Lanes 3-10): the smaller the size of the protein, the farther away it moved from chamber 10 which was the feed point for the sample.

### Example 4

An apparatus according to the present invention containing twelve separation channels was used to separate alpha-1-antitrypsin (AAT, 51 kDa, pI=4.8) from human serum albumin (HSA, 66.5 kDa, pI=4.9). This example demonstrated the use of the invented apparatus with Bier's buffers to carry out quasi-isoelectric focusing separation of components with close pI values in a shallow pH gradient generated from a binary mixture of weak electrolytes.

The separation unit was assembled as follows. All ion-permeable barriers were polyacrylamide membranes with two different nominal molecular mass cut-offs (NMM). The ion-permeable barriers between the anode chamber and the 1^{st} separation chamber, as well as between the 12^{th} separation chamber and the cathode chamber had an NMM of 5,000 dalton. All other barriers between the 1^{st} and 2^{nd}, 2^{nd} and 3^{rd}, 3^{rd} and 4^{th}, 4^{th} and 5^{th}, 5^{th} and 6^{th}, 6^{th} and 7^{th}, 7^{th} and 8^{th}, 8^{th} and 9^{th}, 9^{th} and 10^{th}, 10^{th} and 11^{th} and, finally, 11^{th} and 12^{th} separation chambers had an NMM of 1,000,000 dalton.

The anolyte (2 L) contained 10 mM glycylglycine (gly-gly) and 90 mM MES, at pH 4.01. The catholyte (2L) contained 90 mM gly-gly and 10 mM MES at pH 5.14. All separation chambers contained mixtures (15 mL each) of gly-gly and MES, at concentrations listed in Table 2 to set up the desired shallow pH gradient. The feed sample was prepared by dissolving HSA at a level of 2 mg/mL and AAT at a level of 0.5 mg/mL in 90 mM gly-gly and 10 mM MES buffer. The total sample volume was 20 mL, its initial pH was 5.35. The sample was loaded into separation chamber 12, next to the cathode. The sample was electrophoresed for 4 hours at 600 V. The current was about 40 mA during the separation.

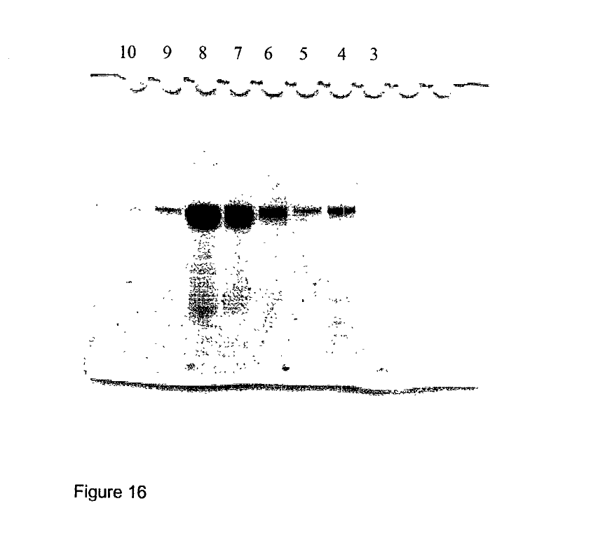

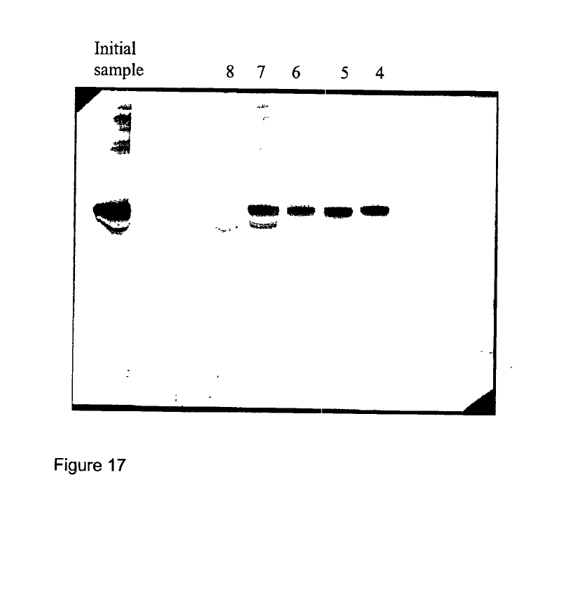

FIG. 16 shows the image of an SDS-PAGE separation of the contents of the separation chambers after 4 hours of electrolysis. FIG. 17 shows the image of a Western blot of the same separation with an antibody against AAT.

HSA had accumulated in separation chambers 10 to 7 (Lanes 10 to 7 in FIG. 16), while AAT accumulated in separation chambers 7 to 4 (Lanes 7 to 4 in FIGS. 16 and 17). Pure AAT could be harvested from separation chambers 6 to 4 (FIG. 17).

TABLE 2
pH gradient preparation and outcomes for the separation of HSA from
AAT.

| | mM gly- | | | | |
|---|---|---|---|---|---|
| Stream | gly | mM MES | start pH | final pH | protein |
| 10 (sample) | 90 | 10 | 5.35 | 5.65 | HSA |
| 9 | 90 | 10 | 5.11 | 5.64 | HSA |
| 8 | 80 | 20 | 4.94 | 5.31 | HSA |
| 7 | 70 | 30 | 4.81 | 5.02 | HSA/AAT |
| 6 | 60 | 40 | 4.72 | 4.86 | AAT |
| 5 | 50 | 50 | 4.64 | 4.74 | AAT |
| 4 | 40 | 60 | 4.55 | 4.53 | AAT |
| 3 | 30 | 70 | 4.45 | 4.29 | — |
| 2 | 20 | 80 | 4.32 | 4.27 | — |
| 1 | 10 | 90 | 4.2 | 4.21 | — |

These examples indicate that remarkably good separation of components can be achieved using the apparatus and method according to the present invention. The high production rates are attributed to the short electrophoretic migration distances, high electric field strength and good heat dissipation characteristics of the system.

The invention has been described herein by way of example only. It will be appreciated skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What we claim is:

1. A multi-port electrophoresis system comprising:
a first electrode chamber containing a cathode;
a second electrode chamber containing an anode, wherein the second electrode chamber is disposed relative to the first electrode chamber so that the cathode and anode are adapted to generate an electric field in an electric field area upon application of a selected electric potential therebetween;
at least three adjacently disposed separation chambers disposed between the electrode chambers so as to be at least partially disposed in the electric field area, wherein each separation chamber is separated from an adjacent separation chamber by a common ion-permeable barrier, wherein separation chambers proximate to each electrode chamber are separated from the respective electrode chamber by at least one ion-permeable barrier, and wherein the ion-permeable barriers are adapted to impede convective mixing of the contents of adjacent chambers;
a first electrolyte reservoir in fluid communication with at least one of the electrode chambers;
at least one sample reservoir, wherein each of the at least one sample reservoirs is in fluid communication with at least one of the separation chambers;
means adapted for communicating fluids to the first and second electrode chambers;
means adapted for communicating an electrolyte between the electrolyte reservoir and at least one of the first and second electrode chambers;
means adapted for communicating fluids to the at least the three separation chambers wherein at least one of the fluids contains a sample; and
means adapted for communicating at least one fluid between at least one separation chamber and the at least one sample reservoir;
wherein application of the selected electric potential causes migration of at least one component through at least one of the ion-permeable barriers.

2. The system according to claim 1 wherein the means adapted for communicating fluids to the first and second electrode chambers include inlet means for communicating fluids to the electrode chambers and outlet means for receiving fluids from the electrode chambers and define first and second electrolyte paths through the first and second electrode chambers respectively, and the means adapted for communicating fluids to the separation chambers include inlet means for communicating fluids into the separation chambers and outlet means for receiving fluids from the separation chambers and define separation flow paths through the respective separation chambers.

3. The system according to claim 1 wherein the system further comprises a second electrolyte reservoir wherein the first and second electrolyte reservoirs are in fluid communication with the first and second electrode chambers respectively.

4. The system according to claim 1 wherein the system is comprised of at least four adjacently disposed separation chambers disposed between the electrode chambers so as to be at least partially disposed in the electric field area, wherein each separation chamber is separated from an adjacent separation chamber by a common ion-permeable barrier and separation chambers proximate to an electrode chamber are separated from the associated electrode chamber by at least one ion-permeable barrier, the ion-permeable barriers are adapted to impede convective mixing of the contents of adjacent chambers, and four sample reservoirs in fluid communication with the respective separation chambers.

5. The system according to claim 1 wherein at least one of the barriers restricts convective mixing of the contents of adjacent chambers and prevents substantial migration of components through the barrier in the absence of an electric field.

6. The system according to claim 1 wherein the barriers are membranes having characteristic average pore sizes and pore size distributions.

7. The system according to claim 1 wherein at least one of the barriers is an isoelectric membrane having a characteristic pI value.

8. The system according to claim 1 wherein at least one of the barriers is an ion-exchange membrane capable of allowing or impeding selective migration of ions through the ion-exchange membrane.

9. The system according to claim 1 wherein the electrodes are comprised of titanium mesh coated with platinum.

10. The system according to claim 1 wherein each separation chamber contains inlet means and outlet means for communicating fluids to each respective separation chamber.

11. The system according to claim 10 wherein at least two of the separation chambers have common inlet means and outlet means for communicating fluids to the at least two separation chambers.

12. The system according to claim 2 wherein at least two of the separation chambers are in serial fluid communication such that fluids first flow through a selected one of the separation chambers and upon exiting the selected one of the separation chambers, the fluids enter the other chamber and flow through the other chamber.

13. The system according to claim 2 wherein at least two of the separation chambers are in parallel fluid communication such that the same fluids flow through the at least two separation chambers and the fluids flow in generally the same flow direction in the at least two separation chambers.

14. The system according to claim 2 wherein at least two of the separation chambers are in parallel fluid communication such that the same fluids flow through the at least two separation chambers and wherein the direction of flow in at least one of the at least two separation chambers is anti-parallel.

15. The system according to claim 1 further comprising
means adapted for circulating electrolyte from the first reservoir through at least one of the first and second electrode chambers forming first and second electrolyte streams in the respective electrode chambers; and
means adapted for circulating fluid content from the at least one sample reservoir through the respective separation chambers forming sample streams in the respective separation chambers.

16. The system according to claim 15 wherein the means adapted for communicating the electrolyte and fluid contents comprise pumping means which are separately controlled for independent movement of the respective electrolyte and fluid contents.

17. The system according to claim 1 further comprising means adapted for at least removing at least a portion of contents from and replacing at least a portion of contents in the at least one sample reservoir.

18. The system according to claim 1 further comprising means adapted to maintain the temperature of contents in at least one of the first electrode chamber, the second electrode chamber, a separation chamber, and the at least one sample reservoir.

19. The system according to claim 18 wherein the means adapted to maintain the temperature is a tube-in-shell beat exchanger.

20. The system according to claim 1 wherein the first electrode chamber, second electrode chamber, and the separation chambers are contained in a separation unit wherein the separation unit is selected from the group consisting of a cassette and a cartridge and such separation unit is fluidly connected to the at least one electrolyte reservoir and the at least one sample reservoir.

21. An electrophoresis separation unit comprising:
a first electrode chamber containing a cathode;
a second electrode chamber containing an anode, wherein the second electrode chamber is disposed relative to the first electrode chamber so that the cathode and anode are adapted to generate an electric field in an electric field area upon application of a selected electric potential therebetween;
at least three adjacently disposed separation chambers disposed between the electrode chambers so as to be at least partially disposed in the electric field area, wherein each separation chamber is separated from an adjacent separation chamber by a common ion-permeable barrier, wherein separation chambers proximate to each electrode chamber are separated from the respective electrode chamber by at least one ion-permeable barrier, and wherein the ion-permeable barriers are adapted to impede convective mixing of the contents of adjacent chambers;
means adapted for communicating fluids to the first and second electrode chambers; and
means adapted for communicating fluids to the at least three separation chambers wherein at least one of the fluids contains a sample;
wherein application of the selected electric potential causes migration of at least one component through at least one of the ion-permeable barriers.

22. The separation unit according to claim 21 wherein the means adapted for communicating fluids to the first and second electrode chambers include inlet means for communicating fluids to the electrode chambers and outlet means for receiving fluids from the electrode chambers and define first and second electrolyte paths through the first and second electrode chambers respectively, and the means adapted for communicating fluids to the separation chambers include inlet means for communicating fluids into the separation chambers and outlet means for receiving fluids from the separation chambers and define separation flow paths through the respective separation chambers.

23. The separation unit according to claim 21 wherein the system is comprised of at least four adjacently disposed separation chambers disposed between the electrode chambers so as to be at least partially disposed in the electric field area, wherein each separation chamber is separated from an adjacent separation chamber by a common ion-permeable barrier and separation chambers proximate to an electrode chamber are separated from the associated electrode chamber by at least one ion-permeable barrier, the ion-permeable barriers are adapted to impede convective mixing of the contents of adjacent chambers.

24. The separation unit according to claim 21 wherein at least one of the barriers restricts convective mixing of the contents of the adjacent chambers and prevents substantial migration of components through the barrier in the absence of an electric field.

25. The separation unit according to claim 21 wherein the barriers are membranes having characteristic average pore sizes and pore size distributions.

26. The separation unit according to claim 21 wherein at least one of the barriers is an isoelectric membrane having a characteristic pI value.

27. The separation unit according to claim 21 wherein at least one of the barriers is an ion-exchange membrane capable of allowing or impeding selective migration of ions through the ion-exchange membrane.

28. The separation unit according to claim 21 wherein the electrodes are comprised of titanium mesh coated with platinum.

29. The separation unit according to claim 21 further comprising:
a cathodic connection block having an exterior surface and interior surface spaced apart from each other and defining a block portion, wherein the interior surface is shaped so as to define a recess, wherein the recess allows the cathode connection block to matingly engage with an upper portion of the separation unit such that at least a portion of the first electrode chamber is disposed within the recess, wherein the cathodic connection block further contains at least one inlet means for communicating fluids to at least one of the separation chambers and at least one outlet means for receiving fluids from at least one of the separation chambers; and
an anodic connection block having an exterior surface and an interior surface spaced apart from each other and defining the block portion, wherein the interior surface is shaped so as to define a recess, wherein the recess allows the anodic connection block to matingly engage with a lower portion of the separation unit such that at least a portion of the second electrode chamber is disposed within the recess, wherein the anodic connection block further contains at least one inlet means for communicating fluids to at least one of the separation chambers and at least one outlet means for receiving fluids from at least one of the separation chambers.

30. The separation unit according to claim 29
wherein the first electrode chamber containing the cathode is disposed in the recess in the interior of the cathodic connection block such that the cathode is at least partially disposed within such recess and wherein the cathodic connection block comprises means adapted for connecting the cathode to an associated power supply; and
wherein the second electrode chamber containing the anode is disposed in the recess in the interior of the anodic connection block such that the anode is at least partially disposed within such recess and wherein the anodic connection block comprises means adapted for connecting the anode to an associated power supply.

31. The separation unit according to claim 29 wherein the cathodic connection block further comprises inlet means for communicating fluid to the first electrode chamber and outlet means for receiving fluid from the first electrode chamber and the anodic connection block further comprises inlet means for communicating fluid to the second electrode chamber and outlet means for receiving fluid from the second electrode chamber.

32. The separation unit according to claim 21 wherein at least two of the separation chambers have common inlet means and outlet means for communicating fluids to the at least two separation chambers.

33. The separation unit according to claim 22 wherein at least two of the separation chambers are in serial fluid communication such that fluids first flow through a selected one of the separation chambers and upon exiting the selected one of the separation chambers, the fluids enter the other chamber and flow through the other chamber.

34. The system according to claim 22 wherein at least two of the separation chambers are in parallel fluid communication such that the same fluids flow through the at least two separation chambers and the fluids flow in generally the same flow direction in the at least two separation chambers.

35. The system according to claim 22 wherein at least two of the separation chambers are in parallel fluid communication such that the same fluids flow through the at least two separation chambers and wherein the direction of flow in at least one of the at least two separation chambers is anti-parallel.

36. The separation unit according to claim 21 wherein the separation chambers are comprised in a cartridge which is adapted to be removable from the separation unit.

37. A cartridge for use in an electrophoresis unit comprising:
a housing including a base section and a plurality of sidewalls sealingly connected thereto so as to define an interior portion;
a first outer ion-permeable barrier disposed within the interior of the housing;
a second outer ion-permeable barrier disposed within the interior of the housing and relative to the first outer ion-permeable barrier so as to define a volume therebetween;
at least two inner ion-permeable barriers disposed between the outer ion-permeable barriers so as to define three adjacently disposed separation chambers, wherein each separation chamber is separated from an adjacent separation chamber by a common ion-permeable barrier, wherein the ion-permeable barriers are adapted to impede convective mixing of the contents of adjacent chambers; and
means adapted for communicating fluids to at least one of the separation chambers.

38. The cartridge according to claim 37 wherein the means adapted for communicating fluids to the separation chambers include inlet means for communicating fluids into the separation chambers and outlet means for receiving fluids from the separation chambers and define separation flow paths through the respective separation chambers, and wherein fluids are caused to stream through the separation chambers without substantial convective mixing of fluids between the chambers.

39. The cartridge according to claim 37 wherein the cartridge further comprises at least one gasket disposed within the interior of the housing and proximate to an outer surface of a selected one of the outer ion-permeable barriers.

40. The cartridge according to claim 37 wherein the cartridge further comprises at least one grid element disposed within a selected one of the separation chambers and proximate to one of the ion-permeable barriers defining such separation chamber.

41. The cartridge according to claim 40 wherein the grid element has a generally planar shape.

42. The cartridge according to claim 40 wherein the interior of the grid element is a lattice arrangement.

43. The cartridge according to claim 37 wherein the cartridge comprises at least three inner ion-permeable barriers disposed between the outer ion-permeable barriers so as to define four adjacently disposed separation chambers, wherein each separation chamber is separated from an adjacent separation chamber by a common ion-permeable barrier, wherein the ion-permeable barriers are adapted to impede convective mixing of the contents of adjacent chambers.

44. The cartridge according to claim 37 wherein at least one of the barriers restricts convective mixing of contents in adjacent chambers and prevents substantial migration of components through the barrier in the absence of an electric field.

45. The cartridge according to claim 37 wherein the barriers are membranes having characteristic average pore sizes and pore size distributions.

46. The cartridge according to claim 37 wherein at least one of the barriers is an isoelectric membrane having a characteristic pI value.

47. The cartridge according to claim 37 wherein at least one of the barriers is an ion-exchange membrane capable of allowing or impeding selective migration of ions through the ion-exchange membrane.

48. The cartridge according to claim 37 wherein each separation chamber contains inlet means and outlet means for communicating fluids to each respective separation chamber.

49. The cartridge according to claim 37 wherein at least two of the separation chambers have common inlet means and outlet means.

50. A method for altering the composition of a sample by electrophoresis comprising:
communicating a first electrolyte to a first electrode chamber containing a cathode;
communicating a second electrolyte to a second electrode chamber containing an anode, wherein the second electrode chamber is disposed relative to the first electrode chamber so that the cathode and anode are adapted to generate an electric field in an electric field area upon application of a selected electric potential therebetween, wherein at least one of the electrode chambers is in fluid communication with an electrolyte reservoir, wherein the second electrolyte is selected from the group consisting of the first electrolyte and an electrolyte different from the first electrolyte;
communicating fluids to at least three adjacently disposed separation chambers disposed between the electrode chambers so as to be at least partially disposed in the electric field area, wherein each separation chamber is separated from an adjacent separation chamber by a common ion-permeable barrier, wherein separation chambers proximate to each electrode chamber are separated from the respective electrode chamber by at least one ion-permeable barrier, and wherein the ion-permeable barriers are adapted to impede convective mixing of the contents of adjacent chambers, wherein at least one of the separation chambers is in fluid communication with at least one sample reservoir, wherein at least one of the fluids contains a sample;
applying of the selected electric potential causes migration of at least one component through at least one of the ion-permeable barriers into at least one the adjacent chambers.

51. The method according to claim 50 further comprising collecting the altered sample from at least one of the chambers.

52. The method according to claim 50 wherein the electrolyte is communicated to the electrode chambers by circulating the electrolyte through inlet means into the respective electrode chambers and out of the respective electrode chambers by outlet means forming electrolyte streams through the respective electrode chambers, and wherein the fluids are communicated to the separation chambers by circulating the fluids through inlet means into the respective separation chambers and out of the respective separation chambers by outlet means forming fluid streams through the respective separation chambers.

53. The method according to claim 50 wherein substantially all trans-barrier migration of components is initiated upon the application of the selected electric potential.

54. The method according to claim 50 wherein at least one of the barriers restricts convective mixing of contents in adjacent chambers and prevents substantial migration of components through the barrier in the absence of an electric field.

55. The method according to claim 50 wherein the barriers are membranes having characteristic average pore sizes and pore size distributions.

56. The method according to claim 50 wherein at least one of the barriers is an isoelectric membrane having a characteristic pI value.

57. The method according to claim 50 wherein at least one of the barriers is an ion-exchange membrane capable of allowing or impeding selective migration of ions through the ion-exchange membrane.
